(19) United States
(12) Patent Application Publication
(10) Pub. No.: US 2017/0147999 A1
(43) Pub. Date: May 25, 2017

(54) ELECTRONIC DEVICE FOR PERFORMING PAYMENT AND METHOD OF OPERATING THE SAME

(71) Applicant: SAMSUNG ELECTRONICS CO., LTD., Suwon-si (KR)

(72) Inventors: Moo-Young KIM, Seoul (KR); Sun-Kee LEE, Seongnam-si (KR); Chung-Geol KIM, Anyang-si (KR); Su-Young PARK, Uiwang-si (KR)

(21) Appl. No.: 15/360,085

(22) Filed: Nov. 23, 2016

(30) Foreign Application Priority Data
Nov. 24, 2015 (KR) 10-2015-0165026

(51) Int. Cl. G06Q 20/10; H04W 4/00; G06Q 20/40

(52) U.S. Cl. CPC G06Q 20/102; G06Q 20/40145; H04W 4/008

(57) ABSTRACT

An electronic device, according to an example embodiment of the present disclosure, may include: a communication module that includes an antenna; one or more sensors; and a processor, wherein the processor is configured to: obtain a gesture input with respect to the electronic device using the one or more sensors; perform a function related to payment if the gesture input satisfies a specified condition; and suppress the execution of the function if the gesture input does not satisfy the specified condition.

### CROSS-REFERENCE TO RELATED APPLICATION

This application is based on and claims priority under 35 U.S.C. §119 to Korean Application Serial No. 10-2015-0165026, which was filed in the Korean Intellectual Property Office on November 24, 2015, the disclosure of which is incorporated by reference herein in its entirety.

### TECHNICAL FIELD

The present disclosure relates generally to a device for performing functions that are related to payment and an operating method thereof, and further relate to a device for performing functions that are related to payment using sensors and an operating method thereof.

### BACKGROUND

In recent years, methods have been provided, in which a terminal adopts a function of making payments by using credit cards in order to thereby enable credit card payments only by letting the terminal approach a payment reader even without the physical cards.

With the introduction of terminals that adopt a payment function based on short-range communications, the terminals may be used as new payment means.

The terminal requires a power level to perform a payment function in order to use the payment function. The user cannot use the payment function when it is needed depending on the power level of the terminal.

### SUMMARY

The various example embodiments of the disclosure provide an electronic device that identifies a user's payment intention through a gesture input and that executes functions that are related to the payment in the low-power state in order to minimize and/or reduce the power consumption, and further provide an operating method thereof and a computer-readable recording medium that stores a program of the operating method.

An electronic device, according to an example embodiment of the present disclosure, may include: a communication module comprising communication circuitry, the communication module including an antenna; one or more sensors; and a processor, wherein the processor is configured to: obtain a gesture input with respect to the electronic device using the one or more sensors; perform a function related to payment if the gesture input satisfies a specified condition; and suppress the execution of the function related to payment if the gesture input does not satisfy the specified condition.

An electronic device, according to an example embodiment of the present disclosure, may include: a wireless communications antenna; a touch screen display; a processor that is electrically connected to the display; and a memory that is electrically connected to the processor, wherein the memory is configured to store instructions that, when executed, cause the processor to: receive a signal or an input that triggers a function related to payment while the electronic device is in a disabled state; receive verification information while the display is, at least in part, turned off in response to receiving the signal or input; perform a verification operation at least based on the verification information; and output information related to the payment to the outside of the electronic device through the antenna based on the verification operation.

According to an example embodiment of the present disclosure, a method of operating an electronic device that includes a communication module comprising communication circuitry, one or more sensors, and a processor may include: obtaining a gesture input with respect to the electronic device using the one or more sensors; performing a function related to payment using the processor if the gesture input satisfies a specified condition; and suppressing the execution of the function related to payment if the gesture input does not satisfy the specified condition.

According to an example embodiment of the present disclosure, a method of operating an electronic device that includes a display, an antenna, and a processor may include: receiving a signal or an input that triggers a function related to payment through the antenna while the electronic device is in a disabled state; receiving verification information while the display is, at least in part, in the disabled state in response to receiving the signal or input; performing a verification operation using the processor at least based on the verification information; and outputting information related to the payment to the outside of the electronic device through the antenna at least based on the verification operation.

The electronic device, according to an example embodiment of the present disclosure, may provide a payment function for minimizing and/or reducing power consumption in the low-power state.

### BRIEF DESCRIPTION OF THE DRAWINGS

The above and other aspects, features, and advantages of the present disclosure will be more apparent from the following detailed description, taken in conjunction with the accompanying drawings, in which like reference numerals refer to like elements, and wherein:

FIG. 1 is a block diagram illustrating an example electronic device and a network, according to various example embodiments of the present disclosure;

FIG. 2 is a block diagram illustrating an example electronic device, according to various example embodiments of the present disclosure;

FIG. 3 is a block diagram illustrating an example program module, according to various example embodiments of the present disclosure;

FIG. 4 is a block diagram illustrating an example electronic system, according to an example embodiment of the present disclosure;

FIG. 5 is a block diagram illustrating an example of the first electronic device illustrated in FIG. 4;

FIG. 6 is a block diagram illustrating an example electronic system, according to another example embodiment of the present disclosure;

FIG. 7 is a block diagram illustrating an example processor that is illustrated in FIGS. 5 and 6;

FIG. 8 is a flowchart illustrating an example payment operation of the first electronic device, according to various example embodiments of the present disclosure;

FIG. 9 is a flowchart illustrating an example power mode for the payment operation of the first electronic device, according to various example embodiments of the present disclosure;

FIGS. 10A, 10B and 10C are flowcharts illustrating an example verification operation of the first electronic device depending on the power state, according to various example embodiments of the present disclosure;

FIG. 11 is a data flow diagram illustrating an example payment operation of the first electronic device, according to various example embodiments of the present disclosure;

FIG. 12 is a data flow diagram illustrating an example payment operation of the first electronic device, according to various example embodiments of the present disclosure;

FIG. 13 is a data flow diagram illustrating an example payment operation of the first electronic device, according to various example embodiments of the present disclosure;

FIG. 14 is a data flow diagram illustrating an example payment operation of the first electronic device, according to various example embodiments of the present disclosure;

FIG. 15 is a flowchart illustrating an example booting operation of the first electronic device, according to various example embodiments of the present disclosure;

FIG. 16 is a flowchart illustrating an example booting operation of the first electronic device, according to various example embodiments of the present disclosure; and

FIG. 17 is a flowchart illustrating an example booting operation of the first electronic device, according to various example embodiments of the present disclosure.

### DETAILED DESCRIPTION

Hereinafter, various example embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and ”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

When it is mentioned that one element (e.g., a first element) is “(operatively or communicatively) coupled with/to or connected to” another element (e.g., a second element), it should be construed that the one element is directly connected to the another element or the one element is indirectly connected to the another element via yet another element (e.g., a third element). In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may refer, for example, to the situation in which the device, together with other devices or components, “is able to”. For example, the phrase “processor adapted (or configured) to perform A, B, and C” may refer, for example, to a dedicated processor (e.g., embedded processor, processing circuitry, etc.) for performing the corresponding operations or a generic-purpose processor (e.g., central processing unit (CPU) or application processor (AP)) that can perform the corresponding operations by executing one or more software programs stored in a memory device.

The terms used in the present disclosure are only used to describe example embodiments, and are not intended to limit the present disclosure. A singular expression may include a plural expression unless they are definitely different in a context. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device, or the like, but is not limited thereto. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit), or the like, but is not limited thereto.

According to some embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame, or the like, but is not limited thereto.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.), or the like, but is not limited thereto.

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter), or the like, but is not limited thereto. The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

Hereinafter, an electronic device according to various example embodiments of the present disclosure will be described with reference to the accompanying drawings. In the present disclosure, the term “user” may indicate a person using an electronic device or a device (e.g., an artificial intelligence electronic device) using an electronic device.

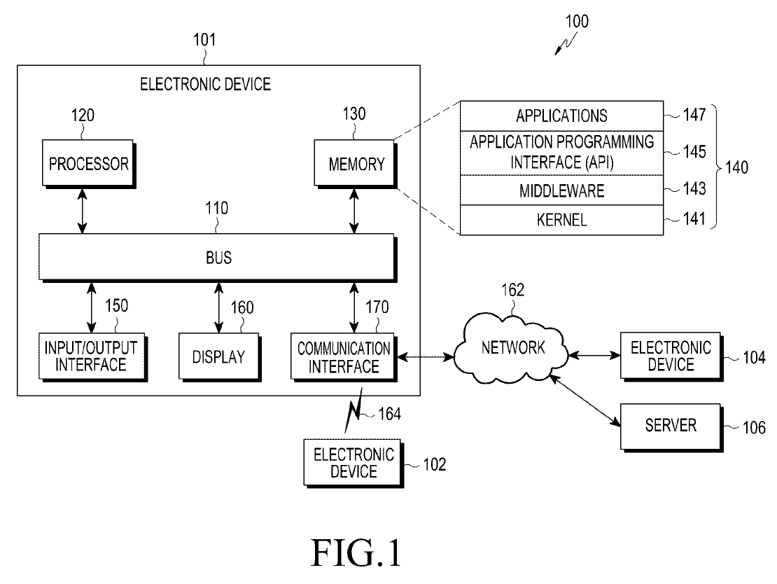

Referring to FIG. 1, an electronic device 101 in a network environment 100 is illustrated, according to various example embodiments of the present disclosure. The electronic device 101 may include a bus 110, a processor (e.g., including processing circuitry) 120, a memory 130, an input/output interface (e.g., including input/output circuitry) 150, a display 160, and a communication interface (e.g., including communication circuitry) 170. In some embodiments, the electronic device 101 may exclude one or more elements or may add other elements thereto.

The bus 110, for example, may include a circuit for connecting the elements 110 to 170 with each other and transferring communication data (e.g., control messages and/or data) between the elements.

The processor 120 may include various processing circuitry, such as, for example, and without limitation, at least one of a central processing unit

(CPU), an application processor (AP), or a communication processor (CP). The processor 120, for example, may process a calculation or data that is related to the control and/or communication of one or more other elements of the electronic device 101.

The memory 130 may include a volatile and/or non-volatile memory. For example, the memory 130 may store instructions or data in relation to one or more other elements of the electronic device 101. According to an embodiment, the memory 130 may store software and/or programs 140. For example, the programs 140 may include a kernel 141, middleware 143, an application programming interface (API) 145, and/or an application programs (or “applications”) 147. At least some of the kernel 141, the middleware 143, or the API 145 may be referred to as an operating system (OS).

The kernel 141, for example, may control or manage system resources (e.g., the bus 110, the processor 120, or the memory 130), which are used to execute the operation or function that is implemented in other programs (e.g., the middleware 143, the API 145, or the application programs 147). In addition, the kernel 141 may provide an interface by which the middleware 143, the API 145, or the application programs 147 may access each element of the electronic device 101 for control or management.

The middleware 143, for example, may play the intermediate role between the API 145 or the application programs 147 and the kernel 141 to communicate with each other for the transmission and reception of data.

In addition, the middleware 143 may process one or more operation requests that are received from the application programs 147 according to the priority. For example, the middleware 143 may give priority for using the system resources (e.g., the bus 110, the processor 120, or the memory 130) of the electronic device 101 to the one or more application programs 147. For example, the middleware 143 may perform scheduling or load balancing for the one or more operation requests by processing the one or more operation requests according to the priority given to the one or more application programs 147.

The API 145, for example, may be an interface by which the application programs 147 control functions that are provided by the kernel 141 or the middleware 143. For example, the API 145 may include one or more interfaces or functions (e.g., instructions) for file control, window control, image processing, or text control.

The input/output interface 150 may include various input/output circuitry that, for example, may play the role of an interface that transfers instructions or data received from a user or other external devices to other elements of the electronic device 101. For example, the input/output interface 150 may include various circuitry configured to output instructions or data received from the other elements of the electronic device 101 to the user or the other external devices.

The display 160, for example, may include a liquid crystal display (LCD), an LED (light emitting diode) display, an organic LED (organic light emitting diode) display, a micro electromechanical system (MEMS) display, or an electronic paper display. For example, the display 160 may display a variety of content (e.g., text, images, videos, icons, symbols, or the like) to the user. The display 160 may include a touch screen, and may receive a touch input, a gesture input, a proximity input, or a hovering input by using electronic pens or a user's body part.

The communication interface 170, for example, may include various communication circuitry to configure communication between the electronic device 101 and external devices (e.g., the first external electronic device 102, the second external electronic device 104, or a server 106). For example, the communication interface 170 may be connected to the network 162 through wireless communication or wired communication in order to thereby communicate with the external devices (e.g., the second external electronic device 104, or the server 106).

For example, the wireless communication may use, as a cellular communication protocol, at least one of LTE (long term evolution), LTE A (LTE Advance), CDMA (code division multiple access), WCDMA (wideband CDMA), a UMTS (universal mobile telecommunications system), WiBro (Wireless Broadband), GSM (Global System for Mobile Communications), or the like. In addition, the wireless communication, for example, may include a short-range communication 164. The short-range communication 164, for example, may include at least one of WiFi (wireless fidelity), Bluetooth, NFC (near field communication), or a GNSS (global navigation satellite system). The GNSS, for example, may include at least one of a GPS (global positioning system), a Glonass (global navigation satellite system), the Beidou Navigation Satellite System (hereinafter, “Beidou”), the Galileo, or the European global satellite based navigation system according to the usage area or bandwidth. Hereinafter, “GPS” may be interchangeably used with “GNSS” in the present specification. For example, the wired communication may include at least one of a USB (universal serial bus), an HDMI (high definition multimedia interface), RS-232 (recommended standard 232), or a POTS (plain old telephone service). The network 162 may include at least one of the telecommunication networks, such as a computer network (e.g., LAN or WAN), the Internet, or a telephone network.

The first external device 102 and the second external device 104 may be the same as, or different from, the electronic device 101 in its type. According to an embodiment, the server 106 may include a group of one or more servers. According to various embodiments, at least some, or all, of the operations that are executed in the electronic device 101 may be executed by one or more other electronic devices (e.g., the electronic device 102 or 104, or the server 106). According to an embodiment, in the case where the electronic device 101 executes a specific function or service automatically or by request, the electronic device 101 may make a request to the other devices (e.g., the electronic device 102 or 104, or the server 106) for at least some of the functions related to the function or service additionally, or instead of, executing the same by itself. The other electronic devices (e.g., the electronic device 102 or 104, or the server 106) may execute the requested function or additional function, and may transfer the result thereof to the electronic device 101. The electronic device 101 may provide the requested function or service by providing the result or by additionally processing the same. To this end, for example, cloud computing, distributed computing, or client-server computing technology may be used.

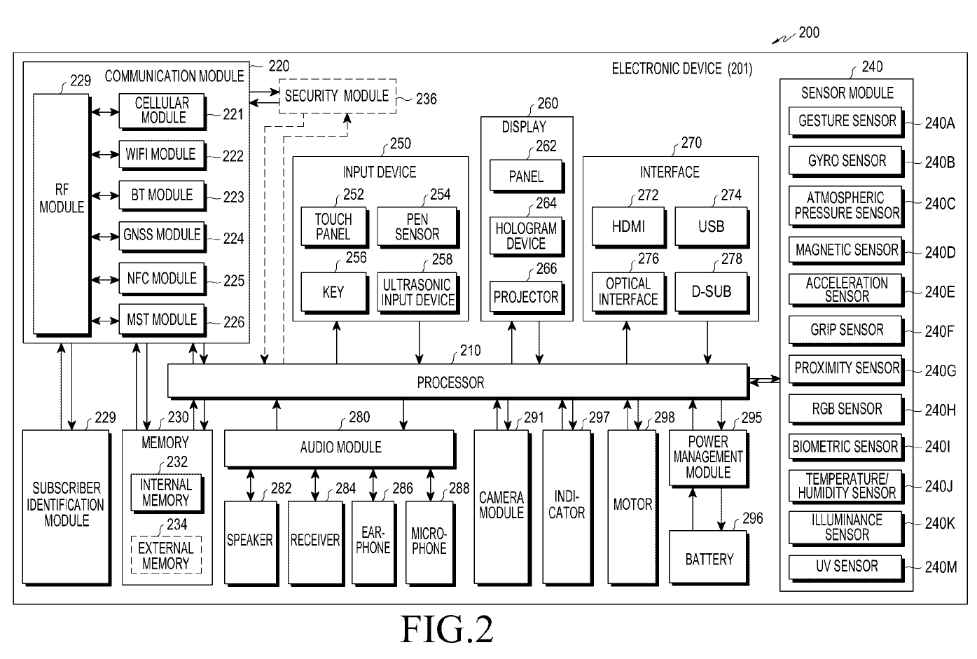

FIG. 2 is a block diagram 200 illustrating an electronic device 201, according to various example embodiments. The electronic device 201, for example, may include all or some of the elements of the electronic device 101 illustrated in FIG. 1. The electronic device 201 may include one or more processors (e.g., application processors (AP)) 210, a communication module (e.g., including communication circuitry) 220, a subscriber identification module 229, a memory 230, a sensor module 240, an input device (e.g., including input circuitry) 250, a display 260, an interface (e.g., including interface circuitry) 270, an audio module 280, a camera module 291, a power management module 295, a battery 296, an indicator 297, or a motor 298.

The processor 210, for example, may control a multitude of hardware or software elements connected with the processor 210, and may perform the processing of various pieces of data and a calculation by executing an operating system or application programs. The processor 210 may be implemented by, for example, processing circuitry, including a system on chip (SoC). According to an embodiment, the processor 210 may further include a graphic processing unit (GPU) and/or an image signal processor. The processor 210 may include at least some (e.g., the cellular module 221) of the elements illustrated in FIG. 2. The processor 210 may load instructions or data received from one or more other elements (e.g., a non-volatile memory) to a volatile memory to then process the same, and may store a variety of data in a non-volatile memory.

The communication module 220 may have the same or a similar configuration as the communication interface 170 of FIG. 1. The communication module 220, for example, may include various communication circuitry, such as, for example, and without limitation, a cellular module 221, a WiFi module 222, a Bluetooth module 223, a GNSS module 224 (e.g., a GPS module, a Glonass module, the Beidou module, or the Galileo module), an NFC module 225, an MST module 226, and a radio frequency (RF) module 227.

The cellular module 221, for example, may include circuitry configured to provide services of voice calls, video calls, text messaging, or the Internet through communication networks. According to an embodiment, the cellular module 221 may perform identification and verification of the electronic device 201 in communication networks by using the subscriber identification module (e.g., a SIM card) 229. According to an embodiment, the cellular module 221 may perform at least some of the functions provided by the processor 210. According to an embodiment, the cellular module 221 may include a communication processor (CP).

For example, each of the WiFi module 222, the Bluetooth module 223, the GNSS module 224, the NFC module 225, or the MST module 226 may include a processor for processing data transmitted and received through the corresponding module. According to an embodiment, at least some (e.g., two or more) of the cellular module 221, the WiFi module 222, the Bluetooth module 223, the GNSS module 224, the NFC module 225, or the MST module 226 may be included in one integrated chip (IC) or one IC package.

The RF module 227 may include circuitry configured to transmit and receive communication signals (e.g., RF signals). The RF module 227 may include, for example, a transceiver, a power amp module (PAM), a frequency filter, a low noise amplifier (LNA), antennas, or the like. According to another embodiment, at least one of the cellular module 221, the WiFi module 222, the Bluetooth module 223, the GNSS module 224, the NFC module 225, or the MST module 226 may transmit and receive RF signals through a separate RF module.

The subscriber identification module 229, for example, may include a card that adopts a subscriber identification module card and/or an embedded

SIM, and may contain inherent identification information {e.g., an integrated circuit card identifier (ICCID)} or subscriber information {e.g., an international mobile subscriber identity (IMSI)}.

The memory 230 (e.g., the memory 130) may include an internal memory 232 or an external memory 234. The internal memory 232, for example, may include at least one of volatile memories {e.g., a dynamic RAM (DRAM), a static RAM (SRAM), a synchronous dynamic RAM (SDRAM), or the like} or non-volatile Memories {e.g., an one time programmable ROM (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash), a hard drive, a solid state drive (SSD), or the like}.

The external memory 234 may include a flash drive, and may further include, for example, compact flash (CF), secure digital (SD), micro secure digital (Micro-SD), mini secure digital (Mini-SD), extreme digital (xD), a memory stick, or the like. The external memory 234 may be functionally and/or physically connected with the electronic device 201 through various interfaces.

A security module 236 may include a storage space of which the security level is relatively higher than that of the memory 230, and may be a circuit that guarantees safe data storage and a protected execution environment. The security module 236 may be implemented by a separate circuit, or may include a separate processor. The security module 236, for example, may be included in detachable smart chips or in secure digital (SD) cards, or may include an embedded secure element (eSE) that is embedded in a fixed chip of the electronic device 201. In addition, the security module 236 may be operated by an operating system (OS) that is different from the operating system of the electronic device 201. For example, the security module 236 may be operated based on a java card open platform (JCOP) operating system.

The sensor module 240, for example, may measure physical quantities or may detect the operation state of the electronic device 201 to thereby convert the measured or detected information to electric signals. The sensor module 240 may include at least one of, for example, a gesture sensor 240A, a gyro-sensor 240B, an atmospheric pressure sensor 240C, a magnetic sensor 240D, an acceleration sensor 240E, a grip sensor 240F, a proximity sensor 240G a color sensor 240H (e.g., a red-green-blue (RGB) sensor), a biometric sensor 240I, a temperature/humidity sensor 240J, an illuminance (e.g., light) sensor 240K, or an ultra violet (UV) sensor 240M. Alternatively or additionally, the sensor module 240, for example, may further include an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor 5 module 240 may further include a control circuit for controlling one or more sensors included therein. In some embodiments, the electronic device 201 may further include a processor as a part of the processor 210 or separately from the processor 210, which is configured to control the sensor module 240 in order to thereby control sensor module 240 while the processor 210 is in a sleep mode.

The input device 250, for example, may include various input circuitry, such as, for example, and without limitation, a touch panel 252, a (digital) pen sensor 254, keys 256, or an ultrasonic input device 258. The touch panel 252 may use at least one of, for example, a capacitive type, a pressure type, an infrared type, or an ultrasonic type. In addition, the touch panel 252 may further include a control circuit. The touch panel 252 may further include a tactile layer in order to thereby provide a user with a tactile reaction.

For example, the (digital) pen sensor 254 may be a part of the touch panel, or may include a separate recognition sheet. The keys 256 may include, for example, physical buttons, optical keys, or a keypad. The ultrasonic input device 258 may detect ultrasonic waves that are generated in the input means through a microphone (e.g., a microphone 288) to thereby identify data corresponding to the ultrasonic waves.

The display 260 (e.g., the display 160) may include a panel 262, a hologram device 264, or a projector 266. The panel 262 may include the same, or a similar, configuration as the display 160 of FIG. 1. The panel 262 may be implemented to be, for example, flexible, transparent, or wearable. The panel 262 may be configured with the touch panel 252 as a single module. The hologram device 264 may display 3D images in the air by using interference of light. The projector 266 may display images by projecting light onto a screen. The screen may be positioned, for example, inside or outside the electronic device 201. According to an embodiment, the display 260 may further include a control circuit for controlling the panel 262, the hologram device 264, or the projector 266.

The interface 270 may include various interface circuitry, such as, for example, and without limitation, at least one of a high-definition multimedia interface (HDMI) 272, a universal serial bus (UBS) 274, an optical interface 276, or a D-subminiature (D-sub) 278. The interface 270 may be included in, for example, the communication interface 170 illustrated in FIG. 1. Additionally or alternatively, the interface 270 may include, for example, a mobile high-definition link (MHL) interface, a secure digital (SD) card/multi-media card (MMC) interface, or an infrared data association (IrDA) standard interface.

The audio module 280, for example, may convert a sound into an electric signal, and vice versa. At least some elements of the audio module 280 may be included, for example, in the input/output interface 150 illustrated in FIG. 1. For example, the audio module 280 may process voice information that is input or output through a speaker 282, a receiver 284, earphones 286, or a microphone 288.

The camera module 291, for example, may be a device for photographing still and moving images, and, according to an embodiment, the camera module 291 may include one or more image sensors (e.g., a front sensor or a rear sensor), lenses, an image signal processor (ISP), or a flash (e.g., an LED or a xenon lamp).

The power management module 295, for example, may manage the power of the electronic device 201. According to an embodiment, the power management module 295 may include a power management integrated circuit (PMIC), a charger integrated circuit (IC), or a battery or fuel gauge. The PMIC may be implemented by a wired charging type and a wireless charging type. The wireless charging type may encompass, for example, a magnetic resonance type, a magnetic induction type, or an electromagnetic wave type, and additional circuits for wireless charging, such as coil loops, resonance circuits, or rectifiers, may be provided. The battery gauge may measure, for example, the remaining power of the battery 296, a charging voltage, current, or temperature. The battery 296 may include, for example, a rechargeable battery or a solar battery.

The indicator 297 may display a specific state (e.g., a booting state, a message state, or a charging state) of the whole or a part (e.g., the processor 210) of the electronic device 201. The motor 298 may convert an electric signal to a mechanical vibration, and may provide a vibration or a haptic effect. Although it is not shown in the drawing, the electronic device 201 may include a processing device (e.g., a GPU) for supporting mobile TV. The processing device for supporting mobile TV may process media data according to standards, such as, for example, digital multimedia broadcasting (DMB), digital video broadcasting (DVB), or mediaFlo™.

Each of the above-described component elements of hardware according to the present disclosure may be configured with one or more components, e.g., including circuitry, and the names of the corresponding component elements may vary based on the type of electronic device. In various embodiments, the electronic device may include at least one of the above-described elements. Some of the above-described elements may be omitted from the electronic device, or the electronic device may further include additional elements. Also, some elements of the electronic device according to various embodiments may be combined into one entity, which may perform functions identical to those of the corresponding elements before the combination.

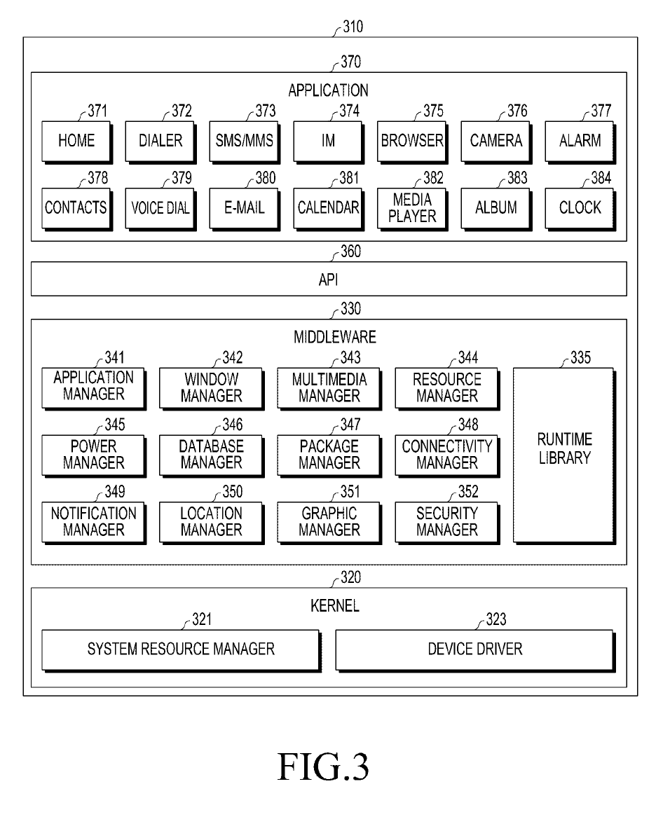

FIG. 3 is a block diagram illustrating an example program module, according to various example embodiments. According to an example embodiment, the program module 310 (e.g., the programs 140) may include an operating system (OS) for controlling resources that are related to the electronic device (e.g., the electronic device 101) and/or various applications (e.g., the application programs 147) that are operated under the operating system. For example, the operating system may be Android, iOS, Windows, Symbian, Tizen, Bada, or the like.

The program module 310 may include a kernel 320, middleware 330, an application programming interface (API) 360, and/or applications 370. At least some of the program module 310 may be preloaded in the electronic device, or may be downloaded from external electronic devices (e.g., the electronic devices 102 and 104, or the server 106).

The kernel 320 (e.g., the kernel 141), for example, may include a system resource manager 321 and/or a device driver 323. The system resource manager 321 may perform control, allocation, or collection of the system resources. According to an embodiment, the system resource manager 321 may include a process management unit, a memory management unit, or a file system management unit. The device driver 323 may include, for example, a display driver, a camera driver, a Bluetooth driver, a shared memory driver, a USB driver, a keypad driver, a Wi-Fi driver, an audio driver, or an inter-process communication (IPC) driver.

The middleware 330, for example, may provide functions required in common for the applications 370, or may provide various functions through the API 360 in order to allow the applications 370 to effectively use limited system resources in the electronic device. According to an embodiment, the middleware 330 (e.g., the middleware 143) may include at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The run time library 335, for example, may include a library module that a compiler uses in order to add new functions through programming languages while the applications 370 are executed. The run time library 335 may perform the input/output management, the memory management, or a function of an arithmetic calculation.

The application manager 341, for example, may manage a life cycle of at least one of the applications 370. The window manager 342 may manage a GUI resource used in the screen. The multimedia manager 343 may identify formats for reproducing various media files, and may perform encoding or decoding of media files by using a codec corresponding to each format. The resource manager 344 may manage resources, such as source codes, memories, or storage spaces of one or more applications 370.

The power manager 345, for example, may manage a battery or power by operating in association with a basic input/output system (BIOS), and may provide power information that is necessary for the operation of the electronic device. The database manager 346 may manage to create, retrieve, or change a database that is to be used in one or more applications 370. The package manager 347 may manage the installation or updating of the applications that are distributed in the form of a package file.

The connectivity manager 348, for example, may manage a wireless connection, such as Wi-Fi or Bluetooth. The notification manager 349 may display or notify of events (such as received messages, appointments, or proximity notifications) to the user without disturbance. The location manager 350 may manage location information of the electronic device. The graphic manager 351 may manage graphic effects to be provided to the user or to user interfaces related thereto. The security manager 352 may provide a general security function required for the system security or user authentication. According to an embodiment, in the case of the electronic device (e.g., the electronic device 101) adopting a phone call function, the middleware 330 may further include a telephony manager for managing the functions of a voice call or a video call of the electronic device.

The middleware 330 may include a middleware module through a combination of various functions of the above-described elements. The middleware 330 may provide a module that is specialized according to the type of operating system in order to provide differentiated functions. In addition, the middleware 330 may dynamically exclude some of the typical elements or add new elements.

The API 360 (e.g., the API 145), for example, may be a group of API programming functions, and may be provided as a different configuration according to an operating system. For example, one set of APIs may be provided to each platform in the case of Android or iOS, and two or more sets of APIs may be provided to each platform in the case of Tizen.

The applications 370 (e.g., the application programs 147) may include one or more applications that execute functions of home 371, a dialer 372, SMS/MMS 373, instant messages (IM) 374, a browser 375, a 25 camera 376, an alarm 377, contacts 378, voice dial 379, e-mail 380, a calendar 381, a media player 382, an album 383, a clock 384, healthcare (e.g., measuring the amount of exercise or blood glucose), providing environment information (e.g., providing atmospheric pressure, humidity, or temperature information), or the like.

According to an embodiment, the applications 370 may include an application (hereinafter, referred to as “information-exchange application” for the convenience of explanation) that supports the exchange of information between the electronic device (e.g., the electronic device 101) and the external electronic device (e.g., the electronic device 102 or 104). The information-exchange application, for example, may include a notification relay application for relaying specific information to the external electronic devices, or may include a device management application for managing the external electronic devices.

For example, the notification relay application may include a function of transferring notification information generated in other applications (e.g., the SMS/MMS application, the e-mail application, the healthcare application, or the environment information application) of the electronic device to the external electronic device (e.g., the electronic device 102 or 104). In addition, the notification relay application, for example, may receive notification information from the external electronic device to then provide the same to the user.

The device management application, for example, may manage (e.g., install, delete, or update): one or more functions {e.g., turning on and off the external electronic device (or some elements) or adjusting the brightness (or resolution) of a display} of the external electronic device (e.g., the electronic device 102 or 104) that communicates with the electronic device; applications executed in the external electronic device; or services (e.g., a phone call service or a messaging service) provided by the external electronic device.

According to an embodiment, the applications 370 may include applications that are designated according to the attribute (e.g., the healthcare application of a mobile medical device) of the external electronic device (e.g., the electronic device 102 or 104). According to an embodiment, the applications 370 may include applications that are received from the external electronic device (e.g., the server 106 or the electronic device 102 or 104). According to an embodiment, the applications 370 may include preloaded applications or third party applications that can be downloaded from a server. The names of the elements of the program module 310, according to the embodiment, may vary depending on the type of operating system.

According to various embodiments, at least some of the program module 310 may be implemented by software, firmware, hardware, or a combination thereof. At least some of the program module 310, for example, may be implemented (e.g., executed) by the processor (e.g., the processor 120). At least some of the program module 310, for example, may include modules, program routines, sets of instructions, or processors for executing one or more functions.

The term “module” as used herein may, for example, refer to a unit including one of hardware (e.g., circuitry), software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of circuitry, processing circuitry (e.g., a CPU), an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may be, for example, the memory 130.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Furthermore, some operations may be executed in a different order or may be omitted, or other operations may be added. Various embodiments disclosed herein are provided merely to easily describe technical details of the present disclosure and to help the understanding of the present disclosure, and are not intended to limit the scope of the present disclosure. Accordingly, the scope of the present disclosure should be construed as including all modifications or various other embodiments based on the technical idea of the present disclosure.

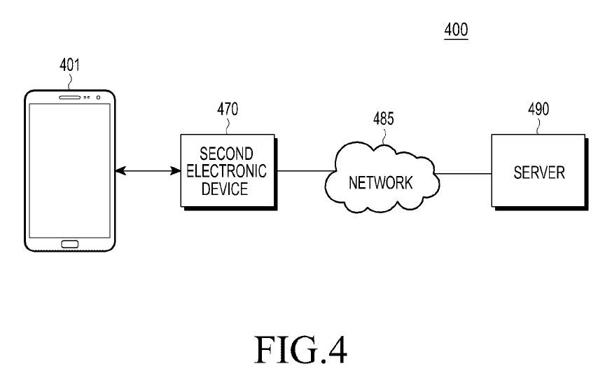

FIG. 4 is a block diagram illustrating an example electronic system, according to an example embodiment of the present disclosure.

Referring to FIG. 4, the electronic system 400 may include a first electronic device 401, a second electronic device 470, a network 485, and a server 490.

The electronic system 400 may refer to a system in which the first electronic device 401 performs a payment function in response to a payment signal that is received from the second electronic device 470. In addition, the electronic system 400 may refer to a system in which the first electronic device 401 performs a payment function in response to a payment signal that is received from the second electronic device 470 even when the first electronic device 401 is in the low-power state.

In the present specification, according to an embodiment, the payment function (or the payment) may refer, for example, to an operation of making payment by using payment means (e.g., credit card information), which are stored in the first electronic device. For example, the payment means may refer to physical cards, web cards, mobile cards, gift cards, cash cards, check cards, and/or other means for making payment.

According to the embodiment, the payment function may include a verification processing operation (or verification operation) for payment and a payment processing operation (or payment operation). According to an embodiment, the first electronic device 401 may perform the payment function by using an application that is related to the payment function. For example, the first electronic device 401 may perform the payment-related function by using a payment application or a verification application.

For example, when a payment signal is received from the second electronic device 470, the first electronic device 401 may enable the payment application to perform the payment. In addition, the first electronic device 401 may obtain user's biometric information by the verification application in order to thereby perform the verification for the payment.

The first electronic device 401 may refer to a device that performs the payment function in response to the payment signal that is received from the second electronic device 470.

According to an embodiment, the payment signal may refer, for example, to a signal that is received from the second electronic device 470 when the first electronic device 401 performs the payment function. For example, the payment signal may refer to information that informs the first electronic device 401 of the initiation of the payment operation.

According to the embodiment, the payment signal may contain information (e.g., a message) that is specified by the second electronic device 470. For example, the specified information may be a selection message. In addition, the payment signal may contain information that is related to a payment processing module that performs the payment function of the first electronic device 401.

For example, in the case where the second electronic device 470 performs the payment with respect to the first electronic device 401, the payment signal may refer to a signal that requests information (e.g., the type of credit card, credit card information, credit card priority information and/or payment approval information of a credit card) that is necessary for performing the payment. For example, the payment signal may contain the cost to be paid by the first electronic device 401, the payment location, the payment time, and other information that is related to the payment. In addition, the payment signal may refer, for example, to a signal that triggers the execution of the payment function by the first electronic device 401.

According to an embodiment, the first electronic device 401 may include information on the credit cards that can perform the payment function. For example, the first electronic device 401 may perform the payment function for at least one of the stored credit cards.

According to the embodiment, the first electronic device 401 may be connected with the second electronic device 470, and may receive a payment signal through short-range wireless communication technology. For example, the payment signal may refer, for example, to a signal by which the second electronic device makes a request to the first electronic device for the execution of the payment function for payment. In addition, the payment signal may contain a signal that requests information that is necessary for the payment.

The wireless communication technology may be implemented to be substantially the same as, or similar to, the wireless communication described in FIGS. 1 to 3. For example, the wireless communication technology may use short-range communication technology.

According to an embodiment, in response to the payment signal, the first electronic device 401 may perform the payment function corresponding to the payment signal, and may transmit payment information to the second electronic device 470. For example, the payment information may refer to information that is necessary for the payment of at least one of the credit cards that are stored in the first electronic device 401.

According to an embodiment, the first electronic device 401 may perform the payment function in the low-power state. For example, the low-power state may refer to the state in which the power that is supplied to the first electronic device 401 is equal to, or less than, a constant reference. For example, the low-power state may refer to the state in which the voltage of a battery (e.g., the battery 296) is equal to, or less than, a constant reference voltage (e.g., 3,6V).

The second electronic device 470 may transmit the payment signal to the first electronic device 401. In addition, the second electronic device 470 may transmit, to the server 490, the payment information received from the first electronic device 401 through the network 485.

According to the embodiment, the second electronic device 470 may be connected to the first electronic device 401, and may transmit the payment signal to the first electronic device 401 through the short-range wireless communication.

According to an embodiment, the second electronic device 470 may receive the payment information corresponding to the payment signal from the first electronic device 401, and may transmit the received payment information to the server 490. For example, the second electronic device 470 may transmit the payment information to the server 490 in order to perform the payment of the first electronic device 401.

The first electronic device 401 and the second electronic device 470 may be implemented to be substantially the same as, or similar to, the electronic device 101 described in FIG. 1.

The second electronic device 470 may transmit the payment information (or payment data) to the server 490 through the network 485. In addition, the second electronic device 470 may receive the information (or data) from the server 490.

For example, the second electronic device 470 may transmit the payment information of the first electronic device of 401 to the server 490 through the network 485 by using wired or wireless communication technology.

The network 485 may be implemented to be substantially the same as, or similar to, the network 162 described in FIG. 1.

The server 490 may be implemented to be substantially the same as, or similar to, the server 106 described in FIG. 1.

According to the embodiment, the server 490 may receive, from the second electronic device 470, the payment information of the first electronic device 401 through the network 485. In addition, the server 490 may store the payment information of the first electronic device 401, which is received from the second electronic device 470.

The server 490 may transmit data that is related to the payment information to the second electronic devices 470 through the network 485. For example, the server 490 may transmit, to the second electronic device 470, data on the approval or non-approval of the payment through the network 485.

In addition, the server 490 may transmit, to the first electronic devices 401, the data that is related to the payment information through the network 485. For example, the server 490 may transmit, to the first electronic device 401, the data on the approval or non-approval of the payment through the network 485.

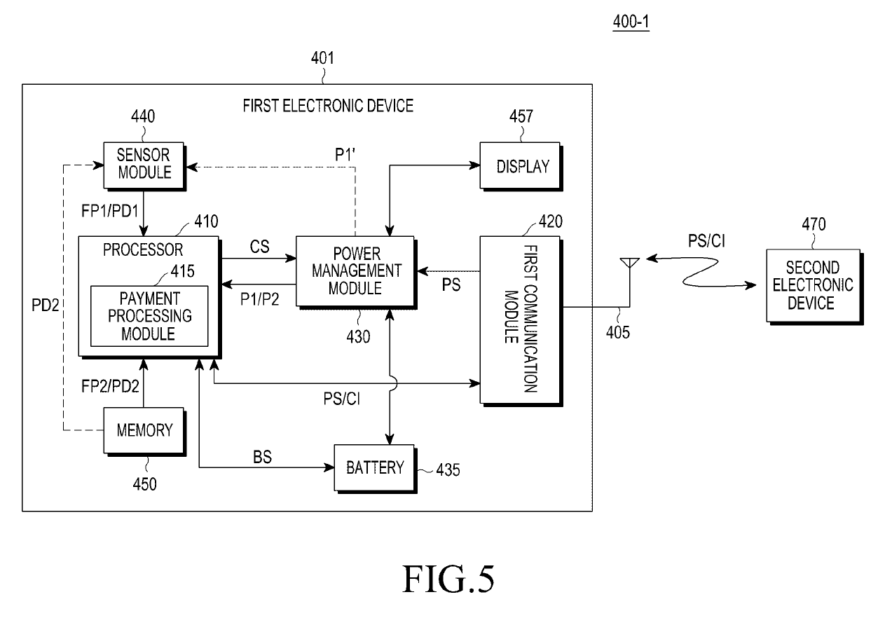

FIG. 5 is a block diagram illustrating an example of the first electronic device that is illustrated in FIG. 4.

Referring to FIG. 5, the electronic system 400-1 may be implemented to be substantially the same as, or similar to, the electronic system 400 described in FIG. 4, except for the network 485 and the server 490.

The first electronic device 401 may receive a payment signal (PS) from the second electronic device 470. The payment signal (PS) may be implemented to be substantially the same as, or similar to, the payment signal described in FIG. 4.

In response to the payment signal (PS), the first electronic device 401 may perform the payment function, and may transmit payment information (CI) to the second electronic device 470. The payment information (CI) may be implemented to be substantially the same as, or similar to, the payment information described in FIG. 4.

The first electronic device 401 may include an antenna 405, a processor (e.g., including processing circuitry) 410, a communication module (e.g., including communication circuitry) 420, a power management module (e.g., including power management circuitry) 430, a battery 435, a sensor module 440, a memory 450, and a display 457.

The antenna 405 may receive the payment signal (PS) from the second electronic device 470. In addition, the antenna 405 may transmit the payment signal (PS) to the communication module 420. According to an embodiment, the antenna 405 may include a coil antenna for the MST, an antenna for the NFC, or a loop antenna for wireless charging.

The processor 410 may control the overall operations of the first electronic device 401.

According to the embodiment, the processor 410 may control the payment function of the first electronic device 401. In addition, the processor 410 may control the payment function of the first electronic device 401 when the first electronic device in the low-power state. For example, the processor 410 may be implemented by a low-power-based processor.

The processor 410 may determine the power state of the first electronic device 401. The processor 410 may control the power management module 430 according to the determination result on the power state.

According to the embodiment, the processor 410 may transmit a control signal (CS) to the power management module 430 according to the power state. For example, the processor 410 may transmit, to the power management module 430, a control signal (CS) to prevent the execution of functions (or modules) that are not required for payment among the functions (or modules) of the first electronic device 401 according to the power state of the first electronic device 401.

The processor 410 may make a control to perform a function (or module) for payment among the functions (or modules) of the first electronic device 401 when the first electronic device 410 is in the low-power state.

According to the embodiment, the processor 410 may make a control to perform only the function (or module) for payment among the functions (or modules) of the first electronic device 401. For example, the processor 410 may make a control to not perform the functions (or modules) that are not required for payment among the functions (or modules) of the first electronic device 401. For example, the processor 410 may transmit, to the power management module 430, a control signal (CS) that allows the display 457 to not operate.

For example, in the case of the low-power state, the processor 410 may transmit, to the power management module 430, a control signal (CS) that prevents the power supply to the display 457 in order to perform the payment function while the display 457 is in the disabled state.

When the first electronic device 401 is in the disabled state, the processor 410 may switch the first electronic device 401 from the disabled state to the enabled state at least based on the payment signal (PS) in order to thereby perform the payment function in the enabled state.

In addition, when the first electronic device 401 is in the disabled state, the processor 410 may maintain the disabled state, and may perform the payment function at least based on the payment signal (PS).

For example, the disabled state may refer to the state in which the power supply to the first electronic device 401 is blocked or in which the first electronic device 401 is in the low-power state (or the state in which the first electronic device 401 is driven by a low power). In addition, the disabled state may refer to the state in which only some elements (or modules) of the first electronic device 401 are operated due to the power state of the first electronic device 401.

The enabled state may refer to the normal power state of the first electronic device 401 (or the state in which the first electronic device 401 is driven by a normal power). In addition, the enabled state may refer, for example, to the state in which all elements (or modules) of the first electronic device 401 are operated or are operable.

For example, the disabled state may refer to the state in which the first electronic device 401 is turned off. In addition, the disabled state may refer to the state in which the first electronic device is in the sleep state. For example, the sleep state may refer to the state in which the first electronic device 401 is operated with a specified consumption current (e.g., 4.5 mA) or less.

The processor 410 may determine whether or not a gesture input (PD1) that is received through the sensor module 440 corresponds to a payment request, and may perform the payment function according to the determination result. In addition, the processor 410 may perform the payment function in response to the payment request that is identified in the sensor module 440.

According to an embodiment, the processor 410 may determine the user's contact state with at least a portion of the first electronic device 401 at least based on the gesture input (PD1) that is obtained through the sensor module 440. For example, the processor 410 may determine whether or not the gesture input (PD1) corresponds to a payment request at least based on the contact state.

The processor 410 may perform a verification operation when performing the payment function. For example, the verification operation may refer to an operation for identifying whether or not the user has been registered in the first electronic device 401 or in an external device (e.g., a credit card company server).

According to the embodiment, the processor 410 may compare the first verification information (FP1) that is received from the sensor module 440 with the second verification information (FP2) that is stored in the memory 450, and may perform the payment function according to the comparison result.

For example, if it is determined that the verification information (FP1) is the same as the second verification information (FP2) stored in the memory 450, the processor 410 may determine that the user has been verified. If the verification is successful, the processor 410 may transmit, to the second electronic device 470, a request for performing the payment by using the communication module 420.

The processor 410 may include a payment processing module 415. In addition, the processor 410 may execute the payment processing module 415. For example, the payment processing module 415 may refer to a payment application or a verification application. For example, the payment application may refer to an application for performing the payment function of the processor 410. For example, the verification application may refer to an application for performing the verification in order for the processor 410 to perform the payment.

The processor 410 may execute the payment application or the verification applications in the background. For example, the operation of executing the application in the background may refer, for example, to the situation in which the payment application or the verification application is executed without being displayed on the display 457.

The payment processing module 415 may perform the payment function of the first electronic device 401. According to the embodiment, the payment processing module 415 may perform the verification operation and the payment operation.

According to an embodiment, the payment processing module 415 may be executed in a payment-dedicated operating system.

The processor 410 may transmit the payment information (CI) to the communication module 420. For example, the payment information (CI) may refer to information for the payment corresponding to the payment signal (PS), which is obtained from a credit card that is stored in the first electronic device 401. In addition, the payment information (CI) may contain information that requests the execution of payment by using the credit card.

For example, the payment information (CI) may contain information on the credit card in order to pay the cost corresponding to the payment signal (PS). In addition, the payment information (CI) may contain information that makes a request for the execution of payment to an external device (e.g., a credit card company server) that is connected to the second electronic device by using the credit card.

The communication module 420 may receive the payment signal (PS) from the antenna 405. Although the antenna 405 is implemented to be separated from the communication module 420 in FIG. 5, the antenna 405 may be included in the communication module 420.

The communication module 420 may be implemented to be substantially the same as, or similar to, the communication module 170 described in FIG. 1. For example, the communication module 420 may receive the payment signal (PS) by using wireless communication technology.

For example, the communication module 420 may include at least one of an NFC module, an MST (magnetic stripe transaction) module, a Bluetooth module, a cellular module, or a Wi-Fi module.

The communication module 420 may transmit the payment signal (PS) to the power management module 430 and the processor 410.

The communication module 420 may transmit the payment information (CI) to the second electronic device 470 through the antenna 405.

The power management module 430 may supply power to each element (e.g., 410, 420, 440, 450, or 457) of the first electronic device 401 for its operation. For example, the power management module 430 may supply power (P1, P1′, and/or P2) to the processor 410 and/or the sensor module 440 in order to perform the payment function of the first electronic device 401.

According to an embodiment, the power management module 430 may control a current (or a voltage) that is applied to each element (e.g., 410, 420, 440, 450, or 457) of the first electronic device 401 according to the control of the processor 410. In addition, according to an embodiment, the processor 410 may determine whether or not to supply power to each element (e.g., 410, 420, 440, 450, or 457) of the first electronic device 401 by using the power management module 430.

According to the embodiment, the power management module 430 may be implemented as a PMIC (power management integrated circuit).

According to the embodiment, the power management module 430 may supply the first power (P1) to the processor 410 in response to the payment signal (PS) that is received from the second electronic device 470. In addition, the power management module 430 may supply the power (P1′) to the sensor module 440 in order to determine whether or not the gesture input (PD1) satisfies a specified condition, according to the control of the processor 410.

According to an embodiment, the power management module 430 may receive a control signal (CS) from the processor 410. For example, the power management module 430 may supply power to the modules that are necessary for the execution of the payment function according to the control signal (CS). For example, the power management module 430 may supply power to the display 457, the sensor module 440, and the communication module 420 to perform the payment function.

In addition, the power management module 430 may not supply power to the modules that are not necessary for the execution of the payment function according to the control signal (CS).

According to an embodiment, the power management module 430 may receive the payment signal (PS) from the communication module 420. For example, the power management module 430 may generate the first power (P1) by using the payment signal (PS). In addition, according to an embodiment, the power management module 430 may generate the second power (P2), which is greater than the first power (P1), by using the payment signal (PS). For example, the power management module 430 may generate the first power (P1) and/or the second power (P2) from the payment signal (PS) by using an induced current.

According to an embodiment, the first power (P1) may be intended to identify whether or not the gesture input (PD1) satisfies a specified condition. For example, the first power (P1) may be generated by using the payment signal (PS). For example, the first power (P1) may be supplied from the battery 435 of the first electronic device 401.

The second power (P2) may be intended to perform the payment function. In addition, the second power (P2) may be intended to perform the verification operation and the payment operation. For example, the second power (P2) may be generated by using the payment signal (PS). In addition, the second power (P2) may be supplied from the battery power 435 of the first electronic device 401.

The battery 435 may store the power for driving the elements of the first electronic device 401 according to the control of the processor 410 or the power management module 430.

The battery 430 may include a fuel gauge that indicates the power state of the battery 435.

The processor 410 or the power management module 430 may determine the power state of the battery 435. For example, the processor 410 or the power management module 430 may control the verification operation and the payment operation at least based on the power state of the battery 435.

For example, the processor 410 may receive a battery state signal (BS) from the battery 435, and may determine the power state of the battery 435 at least based on the battery state signal (BS). In addition, the processor 410 may receive a battery state signal (BS) from the fuel gauge of the battery 435, and may determine the power state of the battery 435 at least based on the battery state signal (BS). In addition, the processor 410 may receive information on the power state of the battery 435 from the power management module 430.

Although the battery 435 is illustrated to be separated from the power management module 430 for the convenience of description in FIG. 5, the battery 435 may be configured to be included in the power management module 430.

The sensor module 440 may sense the gesture input (PD1), and may transmit the sensed gesture input (PD1) to the processor 410.

The sensor module 440 may include a low-power processor. For example, the sensor module 440 may identify whether or not the obtained gesture input (PD1) satisfies a specified condition by using the low-power processor.

According to an embodiment, the processor 410 may determine the user's contact state with respect to at least a portion of the first electronic device 401 at least based on the gesture input (PD1) by using the sensor module 440 (e.g., a grip sensor, a fingerprint sensor, or a touch sensor). For example, the gesture input (PD1) may refer to the touching onto the sensor, the pressing onto the sensor, the user's gripping, or swiping with respect to the first electronic device 401. For example, if it is determined that the user comes into contact with at least a portion of the first electronic device 401 based on the contact state, the processor 410 may determine that the specified condition has been satisfied.

In addition, the low-power processor of the sensor module 440 may determine whether or not the gesture input (PD1) satisfies a specified condition at least based on the contact state.

For example, the sensor module 440 may include a grip sensor, a fingerprint sensor, a touch sensor, a pressure-sensitive sensor, an infrared sensor, an image sensor, a gesture sensor, a gyro sensor, an iris sensor, a camera sensor, a sound sensor, a heart-rate sensor, or an acceleration sensor.

According to an embodiment, the processor 410 may obtain the gesture input (PD1) by using the sensor module 440 (e.g., the infrared sensor, the image sensor, or the acceleration sensor). For example, the gesture input (PD1) may refer to at least one of the type of gesture (e.g., a circle, a triangle, or a square), the size of a gesture, or the speed of a gesture. In addition, the gesture input (PD1) may refer to a specific pattern that corresponds to at least one of the type of a gesture, the size of a gesture, or the speed of a gesture.

For example, the processor 410 may obtain a motion (or state) of at least a part of a user's body with respect to the first electronic device 401 by using an infrared sensor. For example, the processor 410 may obtain a motion of the first electronic device 401 by using an acceleration sensor. For example, the processor 410 may determine at least one of the type, the size, or the speed corresponding to the motion at least based on the motion. For example, if it is determined that the type, the size, or the speed matches a specified type, a specified size, or a specified speed, respectively, the processor 410 may determine that a specified condition has been satisfied.

For example, if the gesture input (PD1) is a touch onto a sensor (e.g., the touch sensor or the fingerprint sensor), the sensor module 440 may transmit, to the processor 410, user's touch information or fingerprint information, which is sensed by using the touch sensor or the fingerprint sensor. In addition, if the gesture input (PD1) is a user's motion with respect to the first electronic device 401 or a motion with respect to the first electronic device 401, the sensor module 440 may transmit, to the processor 410, information on the user's motion by using an acceleration sensor and/or a gesture sensor.

In addition, the gesture input (PD1) may refer to an input that requests the payment of the credit card that is stored in the first electronic device 401 by the user, and, for example, may be a pin-code input, a payment verification key input, a character or number input, and/or picture or text photographing.

In addition, the gesture input (PD1) may be executed while the display 457 is in the power-off (or disabled) state. For example, the processor 410 may detect a user's touch or hovering input with respect to the display 457 while the display 457 is turned off.

According to the embodiment, when the gesture input (PD1) is a touch onto a sensor, the processor 410 may sense the user's touch onto the sensor by using the sensor module 440 in order to thereby obtain touch information or fingerprint information (PD1). The processor 410 may compare the information (PD2) on a payment request, which is stored in the memory 450, with the touch information (PD1), and may perform the payment function according to the comparison result.

According to another embodiment, the sensor module 440 may include a low-power processor. If the gesture input (PD1) is a touch onto a sensor, the sensor module 440 may sense the touch onto the sensor, and may receive information (PD2) for a payment request from the memory 450. The low-power processor of the sensor module 440 may compare the information (PD2) on a payment request with the sensed touch information (PD1) in order to thereby transmit the comparison result to the processor 410. For example, the processor 410 may perform the payment function according to the comparison result that is received from the sensor module 440.

The low-power processor of the sensor module 440 may refer to a processor that consumes less power than the processor 410. For example, low-power processor may refer to a processor that controls the user's touch or motion with respect to the sensors (e.g., the fingerprint sensor, the touch sensor, the gesture sensor 240A, the gyro sensor 240B, or the like) included in the sensor module 440.

According to the embodiment, the processor 410 may obtain at least one of the type, the size, or the speed of a gesture corresponding to the gesture input (PD1) that has been sensed by the sensor module 440. For example, the processor 410 may determine whether or not at least one of the type, the size, or the speed of a gesture satisfies a specified condition.

According to the embodiment, the low-power processor of the sensor module 440 may perform the payment function in response to the user's touch onto the touch sensor or the fingerprint sensor. For example, the user's touch onto the sensor (e.g., the touch sensor), which is detected by the sensor module 440, may refer, for example, to a payment request.

In order for the processor 410 to perform the verification operation, the sensor module 440 may obtain (or sense) the first verification information (FP1). For example, the processor 410 may obtain the first verification information (FP1) from the user by using the sensor module 440 (e.g., the biometric sensor 240I).

According to the embodiment, if the first verification information (FP1) is a user's fingerprint, the processor 410 may obtain the first verification information (FP1) on the user's fingerprint by using the sensor module 440.

In addition, if the first verification information (FP1) is a pin-code number, the processor 410 may receive the first verification information (FP1) on the pin-code number from the user. For example, the processor 410 may receive the first verification information (FP1) on the pin-code number from the user by using a touch screen that is included in the display 457.

The sensor module 440 may transmit the first obtained (or sensed) verification information (FP1) to the processor 410.

The first verification information (FP1) may be information to identify whether or not the user who performs the payment function is a registered user.

According to the embodiment, the first verification information (FP1) may refer to information that is sensed and created by the sensor module 440. For example, the first verification information (FP1) may contain a user's biometric information, fingerprint information, a user's gesture (e.g., the type, the size, and/or the speed of a gesture), a user's grip with respect to the first electronic device 401, and/or the pattern of a gesture.

The second verification information (FP2) may be information to identify whether or not the user who performs the payment function is a registered user.

According to the embodiment, the second verification information (FP2) may refer to information about the user, which is stored in the memory 450. For example, the second verification information (FP2) may contain user's biometric information, fingerprint information, a user's gesture (e.g., the type, the size, and/or the speed of a gesture), a user's grip with respect to the first electronic device 401, and/or the pattern of a gesture, which are predetermined.

The processor 410 may compare the first verification information (FP1) with the second verification information (FP2), and may perform the payment function according to the comparison result.

According to the embodiment, the processor 410 may compare the first verification information (FP1) with the second verification information (FP2), and if the first verification information (FP1) matches the second verification information (FP2), the processor 410 may perform the payment function.

The memory 450 may store the information (PD2) for a payment request, the second verification information (FP2), and/or the payment information (CI). In addition, the memory 450 may store instructions by which processor 410 performs the payment function of the first electronic device 401.

The memory 450 may be implemented to be substantially the same as, or similar to, the memory 130 of FIG. 1. For example, the memory 450 may be implemented by a non-volatile memory.

According to the embodiment, the memory 450 may store the information (PD2) for a payment request, the second verification information (FP2), and/or the payment information (CI) in a security area. For example, the security area may refer to an area that can be accessed only when the access authority is given.

According to the embodiment, the memory 450 may be implemented as an eSE or UICC (universal integrated circuit card).

The display 457 may display the payment information (CI). The display 457 may include a touch screen for receiving a user input and transmitting the received information to the processor 410.

According to the embodiment, the display 457 may be operated partially or as a whole when performing the payment function. For example, the display 457 may display the payment information (CI) while only a portion (e.g., some pixels) of the display is operated.

According to an embodiment, all or a part of the display 457 may not be operated when the first electronic device 401 is in the low-power state. For example, when the first electronic device 401 is in the low-power state, the display 457 may not display the payment information (CI) to the user in the power-off state or in the disabled state.

The disabled state of the display 457 may refer to the state in which the display is turned off or in which some pixels are turned off.

In addition, the disabled state of the display 457 may refer to the state in which some pixels of the display 457 emit (or output) light with a low power consumption. For example, in the case where the pixel elements of the display 457 are LEDs, the display 457 requires low power consumption when the LED elements emit a black light instead of emitting a white light. Therefore, the processor 410 may control the display 457 such that some pixels thereof emit (output) a black light.

The processor 410 may perform the payment function while the display 457 is in the disabled state. For example, the processor 410 perform the payment operation and/or the verification operation even when the display 457 is in the disabled state.

According to an embodiment, the first electronic device 401 may further include an output module (not shown) to provide a notification in relation to the payment. For example, the first electronic device 401 may further include an output module (not shown) to inform of the state of the payment operation or verification operation.

For example, the processor 410 may transmit a state signal to the output module (not shown) according to the state of the payment operation or verification operation.

The output device (not shown) may be implemented by at least one of a vibration device, an optical output device, a speaker (e.g., 282), or an orientation device. For example, the output device (not shown) may inform the user of the state of the payment operation or verification operation by using at least one of a vibration, a light, a sound, or a smell.

The second electronic device 470 may transmit the payment signal (PS) to the first electronic device 410. In addition, the second electronic device 470 may receive the payment information (CI) about the cost corresponding to the payment signal (PS).

The second electronic device 470 may transmit the payment information (CI) to the server 490 through the network 485.

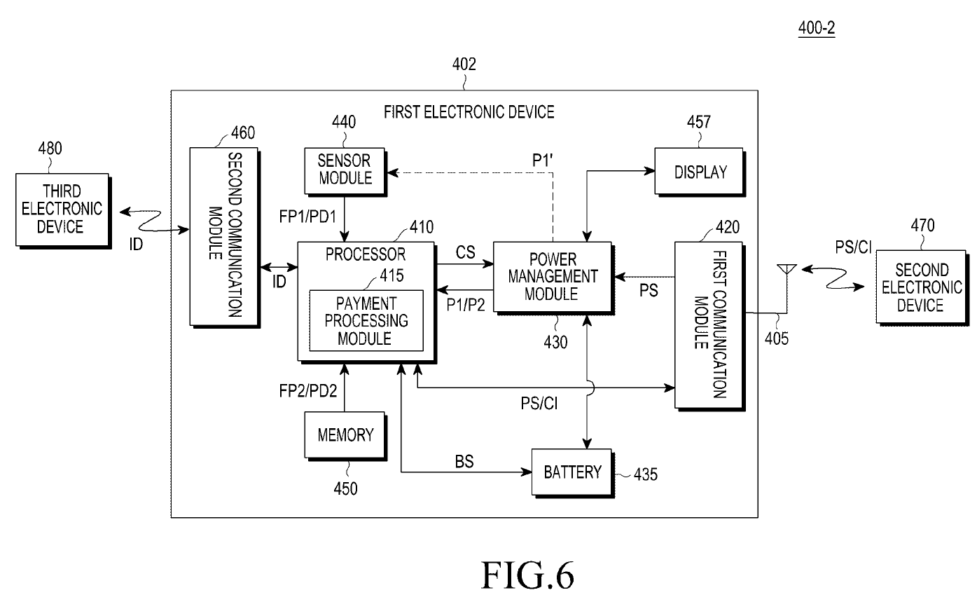

FIG. 6 is a block diagram illustrating an example electronic system, according to another example embodiment of the present disclosure.

Referring to FIG. 6, the electronic system 400-2 may be implemented to be substantially the same as, or similar to, the electronic system 400 described in FIG. 5, except for the third electronic device 480.

The first electronic device 402 may be implemented to be substantially the same as, or similar to, the first electronic device 401 of FIG. 4, except for the second communication module 460.

The first electronic device 402 may perform a payment function in response to the payment signal (PS), and may transmit the payment information

(CI) to the second electronic device 470.

The first electronic device 402 may make a request to the third electronic device 480 for verification information (ID) through the second communication module 460 in order to perform the verification operation.

According to the embodiment, if the gesture input (PD1) corresponds to a payment request, the processor 410 may perform the verification operation.

The processor 410 may make a request to the third electronic device 480 for the verification information (ID) through the second communication module 460.

The second communication module 460 may transmit a signal for requesting the verification information (ID) to the third electronic device 480 under the control of the processor 410.

The third electronic device 480 may perform the verification operation according to the request of the first electronic device 402.

According to the embodiment, the third electronic device 480 may receive the verification information from the user, and may compare the same with verification information that is stored in the storage area of the third electronic device 480.

The third electronic device 480 may create the verification information (ID) by using the comparison result between the verification information received from the user and the stored verification information.

The third electronic device 480 may transmit the verification information (ID) to the first electronic device 402. According to an embodiment, the first electronic device 402 may perform the payment function based on the received verification information (ID).

The third electronic device 480 may be implemented to be substantially the same as, or similar to, the electronic device 101 described in FIG. 1. For example, the third electronic device 480 may be implemented as a wearable electronic device.

The first electronic device 402 may perform the payment function at least based on the verification information (ID). The payment function executed by the first electronic device 402 may be implemented to be substantially the same as, or similar to, the payment function of the first electronic device 401, which has been described in FIG. 5.

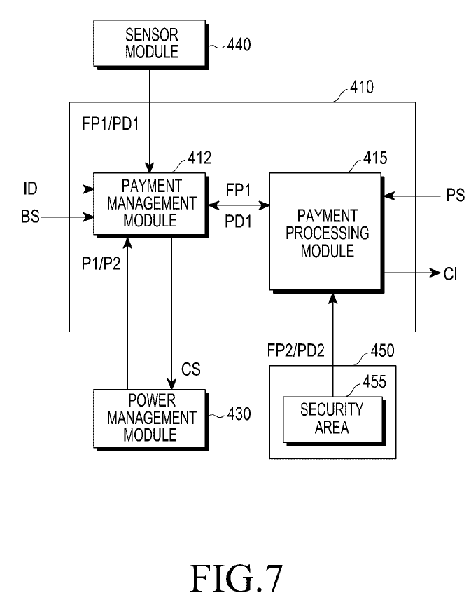

FIG. 7 is a block diagram illustrating an example of the processor that is illustrated in FIGS. 5 and 6.

The processor 410 may include a payment management module (e.g., including payment management circuitry) 412 and a payment processing module (e.g., including payment processing circuitry) 415.

The payment management module 412 may control the overall operations of the processor 410.

The payment management module 412 may be supplied with the first power (P1) from the power management module 430 to determine a specified condition (e.g., to determine whether or not the user touches). For example, the payment management module 412 may obtain the gesture input (PD1) from the sensor module 440 while the first power (P1) is supplied.

The payment management module 412 may control the payment processing module 415 to perform the payment function. For example, the payment management module 412 may be supplied with the second power (P2) from the power management module 430.

In addition, the payment management module 412 may transmit a control signal (CS) to the power management module 430 in order to supply power to each element (e.g., 420, 440, 450, or 457) of the first electronic device 401.

Meanwhile, the payment management module 412 may determine whether or not the gesture input (PD1) received from the sensor module 440 satisfies a specified condition (e.g., a user's touch). If the gesture input (PD1) satisfies a specified condition, the payment management module 412 may enable the payment processing module 415 so as to perform the payment function.

According to another embodiment, if the gesture input (PD1) satisfies a specified condition, the payment management module 412 may make a request to the third electronic device 480 for the verification information (ID).

In addition, the payment management module 412 may make a request to the third electronic device 480 for the verification information (ID) in response to the gesture input (PD1) that is received from the sensor module 440, and may receive the verification information (ID).

The payment management module 412 may transmit, to the payment processing module 415, the verification information (ID) in order for the payment processing module 415 to perform the payment operation in response to the verification information (ID) that is received from third electronic device 480.

The payment management module 412 may receive the first verification information (FP1) from the sensor module 440, and may transmit the first verification information (FP1) to the payment processing module 415.

The payment management module 412 may determine the power state of the battery 435. According to the embodiment, the payment management module 412 may receive a battery state signal (BS) from the battery 435, and may determine the power state of the battery 435 at least based on the received battery state signal (BS). In addition, the payment management module 412 may transmit the battery state signal (BS) to the payment processing module 415.

The payment processing module 415 may control the payment function (e.g., the verification operation) at least based on the power state of the battery 435. According to the embodiment, the payment processing module 415 may control the payment function (e.g., the verification operation) that is performed in the payment processing module 415 at least based on the battery state signal (BS).

The payment processing module 415 may perform the payment function of the first electronic device 401.

According to the embodiment, the payment processing module 415 may perform the verification operation and the payment operation.

The payment processing module 415 may compare the gesture input (PD1) that is received from the payment management module 412 with the information (PD2) on a payment request, which is received from the security area 455 of the memory 450, in order to thereby perform the payment function according to the comparison result.

The memory 450 may store the information (PD2) on a payment request, the second verification information (FP2), and the payment information (CI) in the security area 455. For example, the security area 455 may refer to the area that can be accessed only when the access authority is given.

The payment processing module 415 may access the security area 455 according to the user configuration or program configuration.

The payment processing module 415 may perform the verification operation. For example, the payment processing module 415 may compare the first verification information (FP1) with the second verification information (FP2), and may perform the payment operation according to the comparison result.

The payment processing module 415 may perform the payment operation. For example, the payment processing module 415 may transmit, to the second electronic device 470, the payment information (CI) that is stored in the security area 455 through the communication module 420.

According to another embodiment, the payment processing module 415 may omit the verification operation, and may perform the payment operation.

For example, when the payment management module 412 receives the verification information (ID) from the third electronic device 480, the payment processing module 415 may perform the payment operation according to the verification information (ID). For example, the payment processing module 415 may transmit, to the second electronic device 470, the payment information (CI) through the communication module 420 according to the verification information (ID) without performing the verification operation.

In addition, the payment processing module 415 may perform the payment function according to a payment signal (PS). For example, the payment processing module 415 may transmit, to the second electronic device 470, the payment information (CI) through the communication module 420 without performing the verification operation at least based on the payment signal (PS). For example, if the cost corresponding to the payment signal (PS) is equal to, or less than, a constant amount, the payment processing module 415 may transmit the payment information (CI) to the second electronic device 470 through the communication module 420 without performing the verification operation.

According to another embodiment, after performing the verification operation, the payment processing module 415 may not further perform the verification operation within a specified number of times and/or within a specified time, and may perform the payment function.

For example, after performing the verification operation, the payment processing module 415 may omit the verification operation on the received payment signal (PS) within a specified number of times and/or within a specified time according to the user configuration or program configuration, and may perform the payment function. For example, the payment processing module 415 may not perform the verification operation within a specified number of times and/or within a specified time, and may transmit the payment information (CI) to the second electronic device 470 through the communication module 420.

According to an embodiment, when the first electronic device 401 or 402 is operated by using a payment-dedicated operating system (OS), the payment processing module 415 may perform the payment function of the first electronic device 401 or 402. In addition, when the first electronic device 401 or 402 is operated by using a general operating system (OS), the payment processing module 415 may perform the payment function of the first electronic device 401 or 402.

According to another embodiment, when the first electronic device 401 or 402 is operated by using a general OS, the processor 410 may determine whether or not to operate the device by using the payment-dedicated OS according to the power state of the first electronic device 401 or 402.

For example, if the first electronic device 401 or 402 is in the low-power state, the processor 410 may stop the operation of the general OS, and may operate the first electronic device 401 or 402 with the payment-dedicated OS. When the operating system of the first electronic device 401 or 402 switches from the general OS into the payment-dedicated OS, the payment processing module 415 may perform the payment function based on the payment-dedicated OS.

The general OS may refer to a normal OS to operate the first electronic device 401 or 402. For example, the general OS may be Android.

The payment-dedicated OS may refer to an OS for performing the payment function of the first electronic device 401 or 402. For example, the payment-dedicated OS may be an OS for executing the function (or module) to perform the payment.

For example, the payment-dedicated OS may be an OS that operates only the sensor module 440 for obtaining the verification information of the user and only the NFC module of the communication module 420 for performing the payment among various functions of the first electronic device 401 or 402. In addition, the payment-dedicated OS may control the first electronic device 401 or 402 such that the elements (such as the processor 410 and the memory 450 of the first electronic device 401 or 402) that execute basic functions may operate and the device, such as the display 457, may not operate.

An electronic device, according to various embodiments of the present disclosure, may include: a communication module that includes an antenna; one or more sensors; and a processor, wherein the processor is configured to: obtain a user's gesture input with respect to the electronic device by using the one or more sensors; perform a function that is related to payment if the gesture input satisfies a specified condition; and suppress the execution of the function if the gesture input does not satisfy the specified condition.

The processor may be configured to receive a signal that requests payment from an external electronic device through the communication module when the electronic device is in the disabled state.

The processor may be configured to switch the electronic device from the disabled state into the enabled state at least based on the signal.

The electronic device may further include a low-power processor, and the low-power processor may be configured to perform the function in the disabled state at least based on the signal.

The processor may be configured to obtain the gesture input at least based on the signal.

The one or more sensors may include a grip sensor, a fingerprint sensor, or a touch sensor, and the processor may be configured to: determine the contact state of a user with respect to at least a portion of the electronic device at least based on the gesture input that is obtained by using the grip sensor, the fingerprint sensor, or the touch sensor; and determine that the specified condition has been satisfied if it is determined that the user comes into contact with at least a portion of the electronic device.

The one or more sensors may include an infrared sensor, an image sensor, or an acceleration sensor, and the processor may be configured to: determine the type, the size, or the speed of a gesture corresponding to the gesture input at least based on the gesture input that is obtained by using the infrared sensor, the image sensor, or the acceleration sensor; and determine that the specified condition has been satisfied if it is determined that the type, the size, or the speed matches a specified type, a specified size, or a specified speed, respectively.

The processor may be configured to perform verification on the electronic device or the user by using an application for performing the function.

The sensors may include a fingerprint sensor, an iris sensor, a camera sensor, a sound sensor, or a heart-rate sensor, and the processor may be configured to: obtain one or more pieces of user's biometric information by using a corresponding sensor among the fingerprint sensor, the iris sensor, the camera sensor, the sound sensor, or the heart-rate sensor; and perform the verification and the function at least based on the one or more pieces of biometric information.

The processor may be configured to transmit a request for performing the payment to an external electronic device by using the communication module if the verification is successful.

The electronic device may further include a display, and the processor may be configured to receive information corresponding to the user for the verification while the display is disabled.

The processor may be configured to perform the verification at least based on the power state of the electronic device.

The processor may be configured to receive at least some of the user information from an external electronic device that is functionally connected to the electronic device.

The antenna may include an NFC (near field communication) antenna or an MST (magnetic secure transmission) antenna.

An electronic device, according to various embodiments of the present disclosure, may include: a wireless communications antenna; a touch screen display; a processor that is electrically connected to the display; and a memory that is electrically connected to the processor, wherein the memory may be configured to store instructions that, when being executed, allow the processor to: receive a signal or an input that triggers a function related to payment while the electronic device is in the disabled state; receive verification information while the display is, at least in part, turned off in response to the reception; perform a verification operation at least based on the verification information; and output information that is related to the payment to the outside of the electronic device through the antenna based on the verification operation.

The antenna may include an NFC (near field communication) antenna or an MST (magnetic secure transmission) antenna.

The processor may be configured to switch the electronic device from the disabled state into the enabled state at least based on the signal.

The processor may be configured to receive the verification information while power is not supplied to pixels in a specified area of the display.

The electronic device may further include one or more sensors, and the one or more sensors may include a fingerprint sensor, an iris sensor, a camera sensor, a sound sensor, or a heart-rate sensor, wherein the processor may be configured to obtain the verification information by using the fingerprint sensor, the iris sensor, the camera sensor, the sound sensor, or the heart-rate sensor.

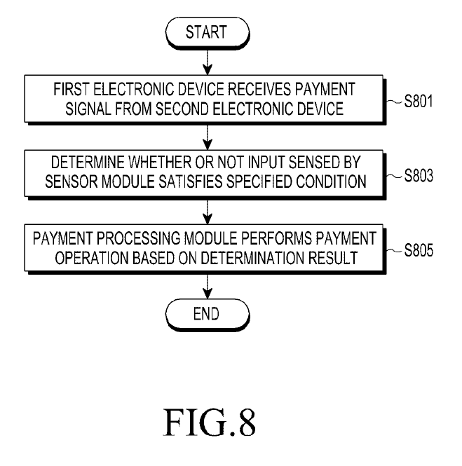

FIG. 8 is a flowchart illustrating an example payment operation of the first electronic device, according to various example embodiments of the present disclosure.

Referring to FIG. 8, the first electronic device 401 or 402 may access the second electronic device 470 using wireless communication technology in order to perform the payment function.

In operation S801, the first electronic device 401 or 402 (e.g., the payment management module 412) may receive a payment signal (PS) from the second electronic device 470. For example, the first electronic device 401 or 402 may receive the payment signal (PS) from the second electronic device 470 by using wireless communication technology in order to perform the payment function.

In operation S803, the first electronic device 401 or 402 (e.g., the payment management module 412) may determine whether or not a gesture input (PD1) that is sensed by the sensor module 440 satisfies a specified condition (e.g., user's contact).

According to the embodiment, the first electronic device 401 or 402 may compare the gesture input (PD1) with information (PD2) on a payment request in order to thereby determine whether or not the gesture input (PD1) satisfies a specified condition. For example, in the case where the specified condition is a user's touch onto the sensor module 440 (e.g., the touch sensor), the payment management module 412 may determine whether or not the user's touch (PD1) has been made onto the sensor module 440 (e.g., the touch sensor). In addition, in the case where the payment request is a specific type of user's grip with respect to the first electronic device 401 or 402, the payment management module 412 may determine whether or not the grip state (PD1) of the user corresponds to the specified type of grip by using the sensor module 440.

If the gesture input (PD1) satisfies a specified condition, the first electronic device 401 or 402 (e.g., the payment processing module 415) may perform the payment function in operation S805. For example, the first electronic device 401 or 402 may make a control to execute a function (or module) for performing the payment operation (or the verification operation) among the functions (or modules) of the first electronic device 401 or 402. In addition, the first electronic device 401 or 402 may make a control to not execute functions (or modules) that are not required for performing the payment operation (or the verification operation) of the first electronic device 401 or 402.

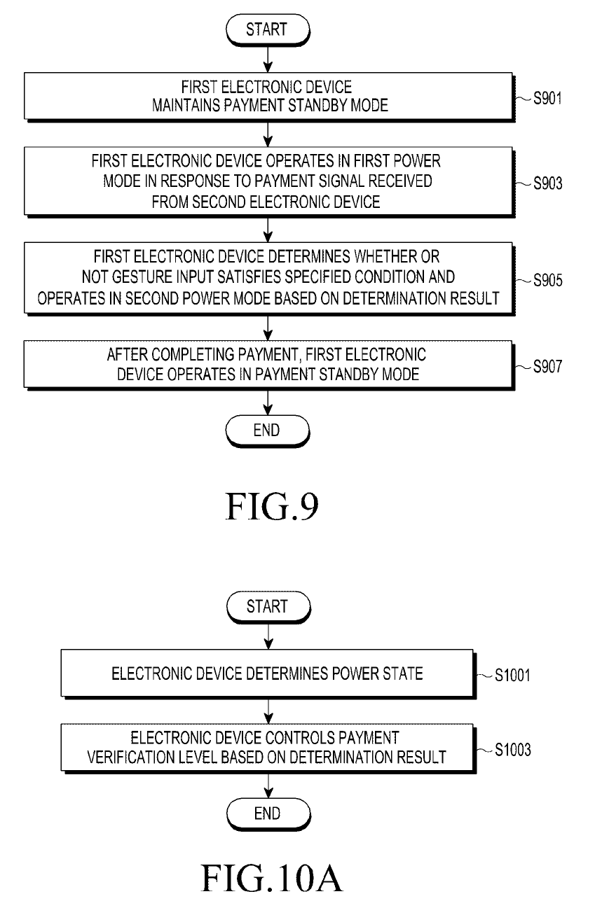

FIG. 9 is a flowchart illustrating an example power mode for the payment operation of the first electronic device, according to various example embodiments of the present disclosure.

Referring to FIG. 9, the first electronic device 401 or 402 may perform the payment function.

In operation S901, the first electronic device 401 or 402 (e.g., the payment management module 412) may maintain a payment standby mode (payment standby state) prior to receiving the payment signal (PS) from the second electronic device 470.

According to an embodiment, the payment standby mode may refer to the state in which the first electronic device 401 or 402 can receive the payment signal (PS). For example, the payment standby mode may refer to the low-power state in which the first electronic device 401 or 402 consumes less power than the normal state.

In addition, the payment standby mode may also refer to a mode in which the first electronic device 401 or 402, which is in the power-off state or in the disabled state, may switch to the power-on state or to the enabled state in response to the payment signal (PS).

In operation S903, the first electronic device 401 or 402 (e.g., the payment management module 412) may operate in the first power mode (or first power state) in response to the payment signal (PS) that is received from the second electronic device 470.

According to an embodiment, the processor 410 (e.g., the payment management module 412) may supply power to at least one of the first sensors in the sensor module 440 in order to determine whether or not a specified condition (e.g., user's contact) is satisfied. For example, the first power mode may refer to the state in which power is supplied to the first sensors (e.g., the touch sensor, the acceleration sensor, and the like) in relation to a gesture in order for the processor 410 to determine a gesture input.

For example, in the first power mode, the processor 410 and the touch sensor of the sensors included in the sensor module 440 may be supplied with the first power (P1). In addition, in the first power mode, only the low power processor and the touch sensor, which are included in the sensor module 440, may be supplied with the first power (P1).

In operation S905, if the gesture input (PD1) satisfies a specified condition (e.g., user's contact), the first electronic device 401 or 402 (e.g., the payment management module 412) may operate in the second power mode (second power state) in order to perform the payment function.

According to an embodiment, the second power mode may refer to the state for performing the payment function by the processor 410. For example, the first electronic device 401 or 402 may supply power to at least one of the second sensors (e.g., the biometric sensor) of the sensor module 440 in order to perform the payment function.

For example, in the second power mode, the processor 410 or the sensor module 440 may be supplied with the second power (P2) from the power management module 430. For example, in the second power mode, the processor 410, and the touch sensor and the fingerprint sensor that are included in the sensor module 440 may be supplied with the second power (P2).

In operation S907, after performing the payment function, the first electronic device 401 or 402 (e.g., the payment management module 412) may operate in the payment standby mode again. For example, the first electronic device 401 or 402 may complete the verification and payment operations, and may then operate in the payment standby mode.

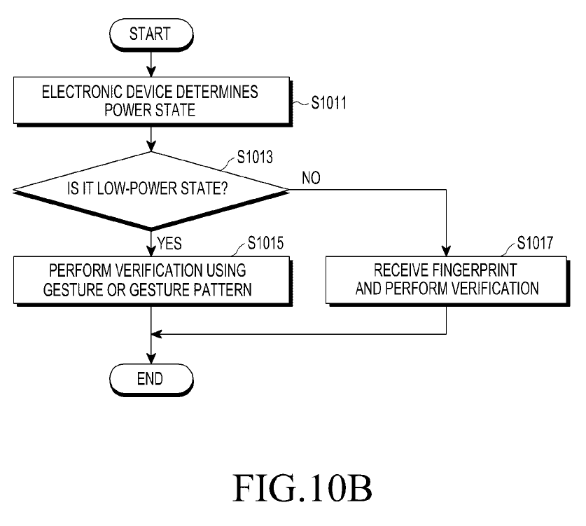

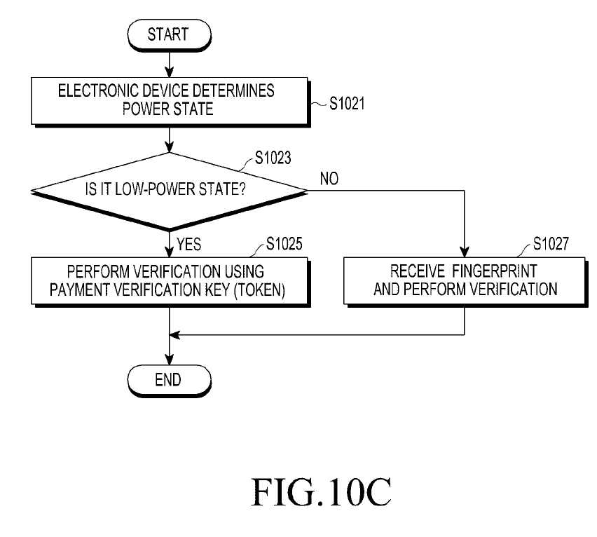

FIGS. 10A, 10B and 10C are flowcharts illustrating an example of the verification operation of the first electronic device depending on the power state, according to various example embodiments of the present disclosure.

Referring to FIG. 10A, in operation S1001, the first electronic device 401 or 402 (e.g., the payment processing module 415) may determine the power state.

The processor 410 (e.g., the payment processing module 415) may control the payment function according to the determined power state.

According to the embodiment, in operation S1003, the first electronic device 401 or 402 (e.g., the payment processing module 415) may control the verification operation among the payment functions according to the determined power state. For example, the processor 410 may control the verification level based on the determined power state.

The processor 410 (e.g., the payment processing module 415) may simplify or omit the verification operation if the first electronic device 401 is in the low-power state.

For example, the processor 410 (e.g., the payment processing module 415) may omit the verification operation in the low-power state if the cost corresponding to the payment signal (PS) is equal to, or less than, a constant amount. In addition, if the gesture input (PD1) is confirmed as being a payment request, the processor 410 may omit the verification operation in the low-power state when the cost corresponding to the payment signal (PS) is equal to, or less than, a constant amount.

In addition, after performing the verification operation, the processor 410 (e.g., the payment processing module 415) may omit the verification operation on the received payment signal (PS) within a specified number of times and/or within a specified time, and may then perform the payment function.

In addition, the processor 410 (e.g., the payment processing module 415) may not perform the verification operation when it is in the low-power state, and when the power state of the first electronic device 401 or 402 becomes normal (for example, the state in which the first electronic device is not in the low-power state), the processor 410 may perform (or request) the verification operation again.

For example, the processor 410 may perform the payment operation without the verification operation when the first electronic device 401 or 402 is in the low-power state, and when the power state of the first electronic device 401 or 402 switches to the normal state, the processor 410 may request the verification operation corresponding to the payment function.

Referring to FIG. 10B, in operation S1011, the first electronic device 401 or 402 (e.g., the processor 410) may determine the power state. In operation S1013, the first electronic device 401 or 402 (e.g., the payment processing module 415) may control the verification operation among the payment functions based on the determined power state (e.g., whether in a low-power state).

In operation S1015, the first electronic device (e.g., the payment processing module 415) may perform the verification operation using a gesture (or a gesture pattern) which is input through the sensor module 440 in the case of the low-power state. For example, the processor 410 (e.g., the payment processing module 415) may compare the gesture input from the user (or the gesture pattern) with a registered gesture (or gesture pattern), and may perform the verification operation according to the comparison result.

In operation S1017, the first electronic device 401 or 402 (e.g., the payment processing module 415) may perform the verification operation using the user's fingerprint which is input through the sensor module 440 when the first electronic device 401 is not in the low-power state.

Referring to FIG. 10C, in operation S1021, the first electronic device 401 or 402 (e.g., the payment processing module 415) may determine the power state.

In operation S1023, the first electronic device 401 or 402 (e.g., the payment processing module 415) may control the verification operation of the payment function based on the determined power state (e.g., whether in a low-power state).

In operation S1025, the processor 410 (e.g., the payment processing module 415) may perform the verification operation by using a payment verification key (token) when the first electronic device 401 is in the low-power state. For example, the processor 410 may compare the payment verification key that is input from the user with a registered payment verification key, and may perform the verification operation according to the comparison result.

For example, the payment verification key (token) may refer to a verification key (token) that is created by the processor or is stored in the security area 455. In addition, the payment verification key (token) may refer to a verification key (token) to determine whether or not the user (or the first electronic device) is a registered user (or electronic device) for the payment. For example, the payment verification key (token) may be implemented by using at least one of a plurality of numbers, characters, or symbols.

In operation S1027, the processor 410 (e.g., the payment processing module 415) may perform the verification operation by using the user's fingerprint, which has been input through the sensor module 440 when the first electronic device 401 is not in the low-power state.

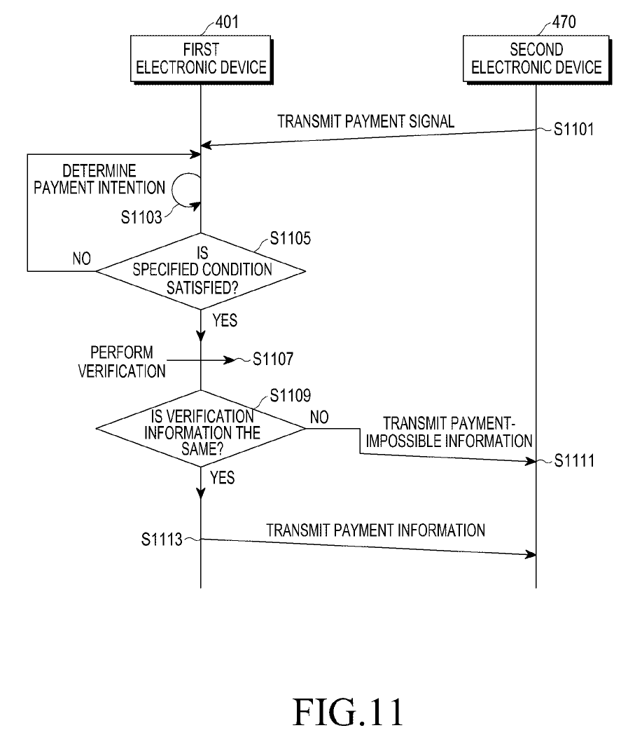

FIG. 11 is a data flow diagram illustrating an example payment operation of the first electronic device, according to various example embodiments of the present disclosure.

Referring to FIG. 11, the first electronic device 401 (e.g., the payment management module 412) may access the second electronic device 470 in order to perform the payment function.

In operation S1101, the first electronic device 401 may receive the payment signal (PS) from the second electronic device 470 using wireless communication technology.

In operation S1103, the first electronic device 401 (e.g., the payment management module 412) may determine the user's payment intention in response to the payment signal (PS).

According to an example embodiment, the first electronic device 401 (e.g., the processor 410) may determine whether or not the gesture input (PD1) satisfies a specified condition (e.g., user's contact) in response to the payment signal (PS). For example, the first electronic device 401 (e.g., the payment management module 412) may determine the user's payment intention at least based on the gesture input (PD1).

In operation S1105, if the gesture input (PD1) satisfies a specified condition, the first electronic device 401 (e.g., the payment management module 412) may perform the payment function.

In operation S1105, if the gesture input (PD1) does not satisfy a specified condition, the first electronic device 401 (e.g., the payment management module 412) may not perform the payment function. For example, the first electronic device 401 (e.g., the payment management module 412) may detect the gesture input (PD1) again without performing the payment function,.

If the gesture input (PD1) satisfies a specified condition, the first electronic device 401 (e.g., the payment management module 412) may perform the verification operation in operation S1107. For example, the verification operation may be executed by using a user's fingerprint, a user's grip, a verification code, a verification number, and a method to determine the registered user.

In operation S1109, the first electronic device 401 (e.g., the payment processing module 415) may compare the first verification information (FP1) that is received from the user with the second verification information (FP2) that is stored in the memory 450 in order to thereby perform the payment operation according to the comparison result.

If the first verification information (FP1) received from the user is different from the second verification information (FP2) stored in the memory 450, the first electronic device 401 (e.g., the payment processing module 415) may transmit, to the second electronic device 470, information stating that the payment is impossible in operation S1111.

If the first verification information (FP1) received from the user is the same as the second verification information (FP2) stored in the memory 450, the first electronic device 401 (e.g., the payment processing module 415) may transmit the payment information (CI) to the second electronic device 470.

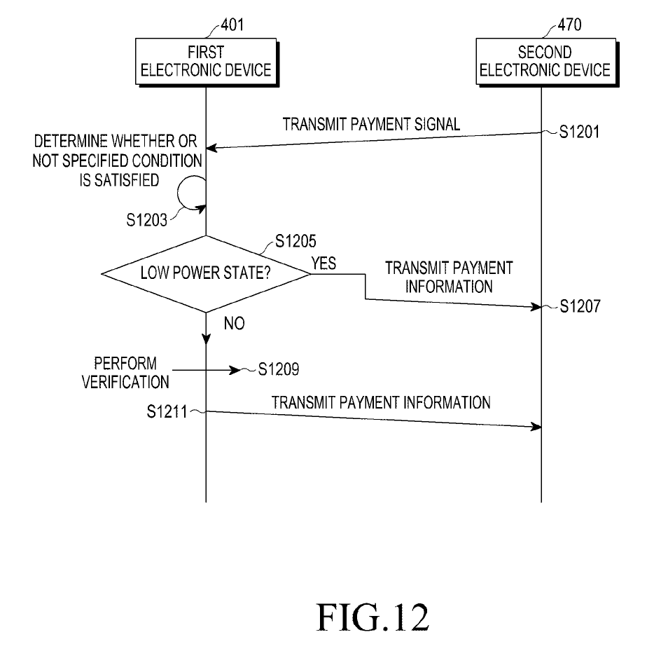

FIG. 12 is a data flow diagram illustrating an example payment operation of the first electronic device, according to various example embodiments of the present disclosure.

Referring to FIG. 12, the first electronic device 401 may access the second electronic device 470 in order to perform the payment function.

In operation S1201, the first electronic device 401 may receive the payment signal (PS) from the second electronic device 470 by using wireless communication technology.

In operation S1203, in response to the payment signal (PS), the first electronic device 401 (e.g., the payment management module 412) may determine whether or not the gesture input (PD1) satisfies a specified condition (e.g., user's contact). For example, the first electronic device 401 (e.g., the payment management module 412) may determine the user's payment intention at least based on the gesture input (PD1).

If the gesture input (PD1) satisfies a specified condition, the first electronic device 401 (e.g., the payment management module 412) may perform the payment function.

In operation S1205, the first electronic device 401 (e.g., the payment processing module 415) may determine the power state of the first electronic device 401.

According to an embodiment, if the first electronic device 401 (e.g., the payment processing module 415) is in the low-power state, the first electronic device 401 (e.g., the payment processing module 415) may control the verification level of the verification operation when performing the payment unction. At this time, the lower-power state may refer to the case in which the power state of the first electronic device 401 is equal to, or less than, a predetermined reference.

According to the embodiment, when the first electronic device 401 is in the low-power state, the first electronic device 401 (e.g., the payment processing module 415) may omit (or regulate) the verification operation according to a predetermined condition in operation S1207. For example, the first electronic device 401 may omit the verification operation in the low-power state, and may transmit the payment information (CI) to the second electronic device 470. For example, the first electronic device 401 (e.g., the payment processing module 415) may be operated by using the payment-dedicated OS.

According to an embodiment, the first electronic device 401 (e.g., the payment processing module 415) may omit the verification operation to then perform the payment function regardless of the power state of the first electronic device 401. For example, the first electronic device 401 (e.g., the payment processing module 415) may omit the verification operation to then perform the payment function according to the user configuration or the program configuration.

In addition, when the first electronic device 401 (e.g., the payment processing module 415) uses the payment-dedicated OS, the first electronic device 401 may omit the verification operation, and may perform the payment function.

If the first electronic device 401 is not in the low-power state (NO in S1205), the first electronic device 401 (e.g., the payment processing module 415) may perform the verification operation in operation S1209.

In operation S1209, the first electronic device 401 (e.g., the payment processing module 415) may compare the first verification information (FP1) that is received from the user with the second verification information (FP2) that is stored in the memory 450 in order to thereby perform the payment operation according to the comparison result.

If the first verification information (FP1) received from the user is the same as the second verification information (FP2) stored in the memory 450, the first electronic device 401 (e.g., the payment processing module 415) may transmit the payment information (CI) to the second electronic device 470 in operation S1211.

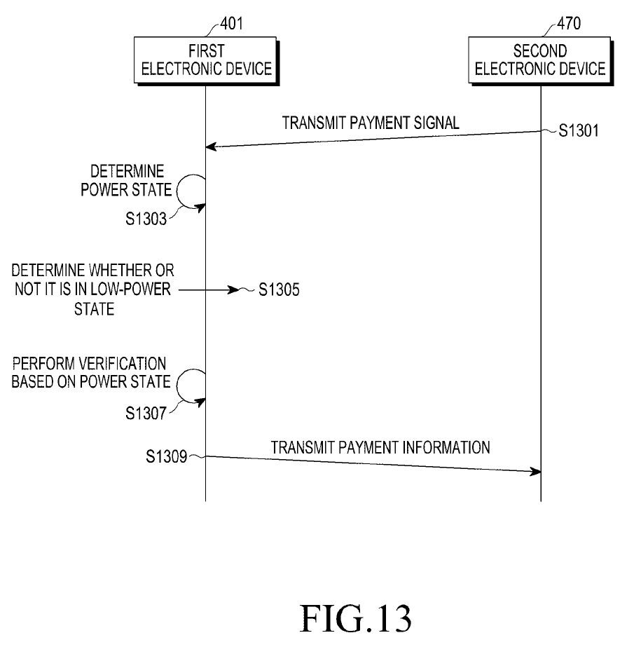

FIG. 13 is a data flow diagram illustrating an example payment operation of the first electronic device, according to various example embodiments of the present disclosure.

Referring to FIG. 13, the first electronic device 401 may access the second electronic device 470 in order to perform the payment function.

In operation S1301, the first electronic device 401 may receive the payment signal (PS) from the second electronic device 470 by using wireless communication technology.

In response to the payment signal (PS), the first electronic device 401 (e.g., the payment management module 412) may determine whether or not the gesture input (PD1) satisfies a specified condition. For example, the first electronic device 401 (e.g., the processor 410) may determine the user's payment intention at least based on the gesture input (PD1).

If the gesture input (PD1) satisfies a specified condition, the first electronic device 401 (e.g., the payment management module 412) may perform the payment function.

In operation S1303, the first electronic device 401 (e.g., the payment processing module 415) may determine the power state of the first electronic device 401 prior to performing the payment function.

In operation S1305, the first electronic device 401 (e.g., the payment processing module 415) may determine the power state (for example, whether or not the first electronic device 401 is in the low-power state). In operation S1307, the first electronic device 401 (e.g., the payment processing module 415) may control the verification level of the verification operation at least based on the determined power state.

If the first electronic device 401 is in the low-power state, the first electronic device 401 (e.g., the payment processing module 415) may control the verification level of the verification operation when performing the payment function.

If the first electronic device 401 is in the low-power state, the first electronic device 401 (e.g., the payment processing module 415) may regulate the verification operation according to a predetermined condition in operation S1307. According to the embodiment, the first electronic device 401 may regulate the verification operation at least based on the payment signal (PS) in operation S1307.

For example, when the first electronic device 401 is in the low-power state, the processor 410 (e.g., the payment processing module 415) may not perform the verification operation. For example, when the first electronic device 401 is in the low-power state, the processor 410 (e.g., the payment processing module 415) may replace the current verification method with a verification method that requires low power consumption. For example, when the first electronic device 401 is in the low-power state, the processor 410 (e.g., the payment processing module 415) may execute the verification by using a gesture pattern instead of the fingerprint verification.

In addition, the first electronic device 401 may be operated by using the payment-dedicated OS.

According to an embodiment, the first electronic device 401 (e.g., the payment processing module 415) may regulate the verification operation and may perform the payment function even when the first electronic device 401 is not in the low-power state. In addition, when regulating the verification operation, the first electronic device 401 may omit the verification operation at least based on the payment information (PS).

For example, the first electronic device 401 (e.g., the payment processing module 415) may regulate the verification operation, and may perform the regulated verification operation at least based on information about the cost that is contained in the payment signal (PS). For example, if the cost corresponding to the payment information (PS) is equal to, or less than, a constant amount, the first electronic device 401 may omit the verification operation to then perform the payment function.

In addition, the first electronic device 401 (e.g., the payment processing module 415) may regulate the verification operation, and may perform the regulated verification operation at least based on information about the location that is contained in the payment information (PS). For example, if the location corresponding to the payment information (PS) is a predetermined location, the first electronic device 401 may omit the verification operation to then perform the payment function.

In operation S1309, the first electronic device 401 (e.g., the payment processing module 415) may perform the regulated verification operation, and may transmit the payment information (CI) to the second electronic device 470.

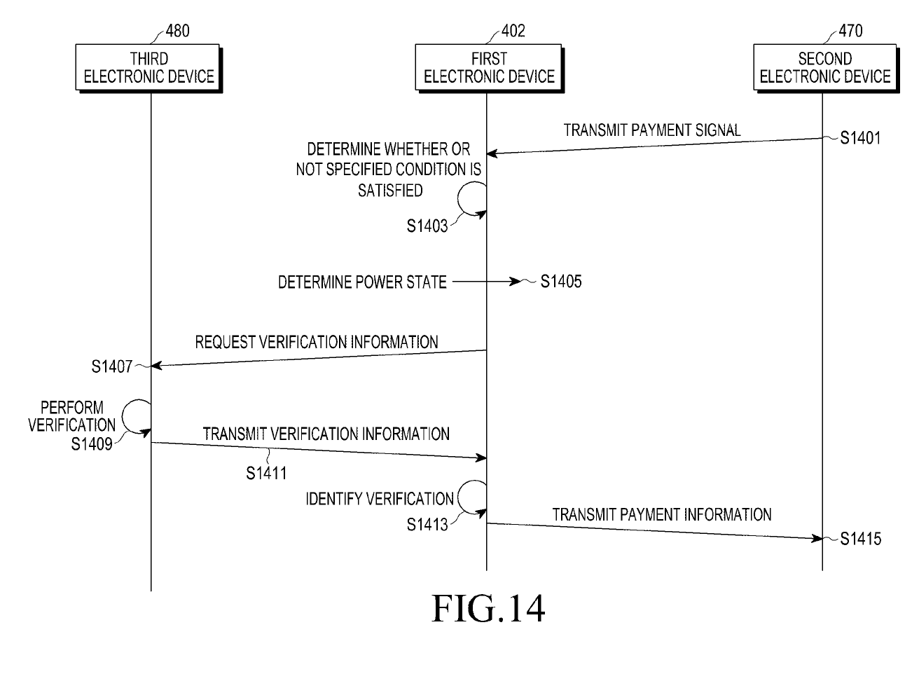

FIG. 14 is a data flow diagram illustrating an example payment operation of the first electronic device, according to various example embodiments of the present disclosure.

Referring to FIG. 14, the first electronic device 402 may access the second electronic device 470 in order to perform the payment function. In addition, the first electronic device 402 may access the third electronic device 480 in order to perform the verification operation.

In operation S1401, the first electronic device 402 (e.g., the payment management module 412) may receive the payment signal (PS) from the second electronic device 470 by using wireless communication technology.

According to the embodiment, in operation S1403, the first electronic device 402 (e.g., the payment management module 412) may determine whether or not the gesture input (PD1) satisfies a specified condition (e.g., user's contact) in response to the payment signal (PS). For example, the first electronic device 402 may determine the user's payment intention at least based on the gesture input (PD1).

If the gesture input (PD1) satisfies a specified condition, the first electronic device 402 (e.g., the payment management module 412) may perform the payment function.

In operation S1405, the first electronic device 402 (e.g., the payment management module 412) may determine the power state of the first electronic device 402 (e.g., the payment management module 412).

If the first electronic device 402 is in the low-power state, the first electronic device 402 (e.g., the payment management module 412) may request the verification information such that the verification operation may be performed by the third electronic device 480.

According to the embodiment, when the first electronic device 402 is in the low-power state, the first electronic device 402 (e.g., the payment management module 412) may make a request to the third electronic device 470 for the verification information (ID) in operation 51407. For example, the first electronic device 402 may be operated by using the payment-dedicated OS.

According to an embodiment, the first electronic device 402 (e.g., the payment management module 412) may allow the third electronic device 480 to perform the verification operation even if the first electronic device 402 is not in the low-power state.

In operation S1409, the third electronic device 480 may perform the verification operation according to request of the first electronic device 402. The third electronic device 480 may perform the verification operation, and may create verification information (ID).

In operation S1411, the third electronic device 480 may transmit the verification information (ID) to the first electronic device 402.

In operation S1413, the first electronic device 402 (e.g., the payment management module 412) may identify the verification information (ID). For example, the first electronic device 402 may identify the verification information (ID) and may determine whether or not the user who is executing the payment is a registered user according to the identification result.

In operation 51415, the first electronic device 402 (e.g., the payment processing module 415) may perform the payment operation at least based on the verification information (ID). For example, the first electronic device 402 may transmit the payment information (CI) to the second electronic device 470 based on the verification information (ID).

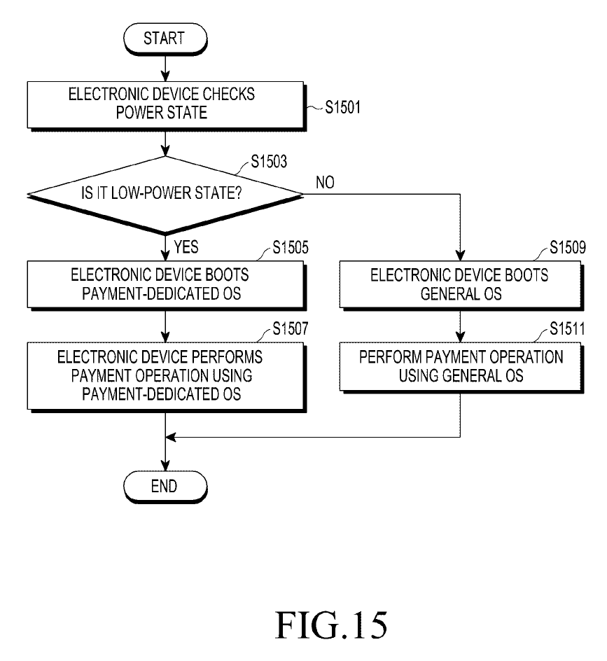

FIG. 15 is a flowchart illustrating an example booting operation of the first electronic device, according to various example embodiments of the present disclosure.

Referring to FIG. 15, the first electronic device 401 or 402 may include a payment-dedicated OS that is related the payment function.

In operation S1501, the first electronic device 401 or 402 (e.g., the payment management module 412) may check the power state of the first electronic device 401 or 402 in response to the payment signal (PS),.

In operation S1503, the first electronic device 401 or 402 (e.g., the payment management module 412) may identify the power state of the first electronic device 401 or 402 through the power management module 430. For example, the processor 410 may determine whether or not the first electronic device 401 or 402 is in the low-power state.

If the first electronic device 401 or 402 is in the low-power state, the processor 410 may perform the payment-dedicated OS in operation S1505.

According to the embodiment, if the first electronic device 401 or 402 is in the low-power state, the processor 410 (e.g., the payment management module 412) may boot the payment-dedicated OS.

In operation S1507, the first electronic device 401 or 402 (e.g., the payment processing module 415) may perform the payment function in the payment-dedicated OS. In addition, the first electronic device 401 or 402 may perform the payment function using the payment processing module 415.

If the first electronic device 401 or 402 is not in the low-power state, the processor 410 may boot a general OS in operation S1509.

In operation S1511, the first electronic device 401 or 402 (e.g., the payment processing module 415) may perform the payment function in the general OS. In addition, the processor 410 may execute the payment function and applications other than the payment function using the generic OS.

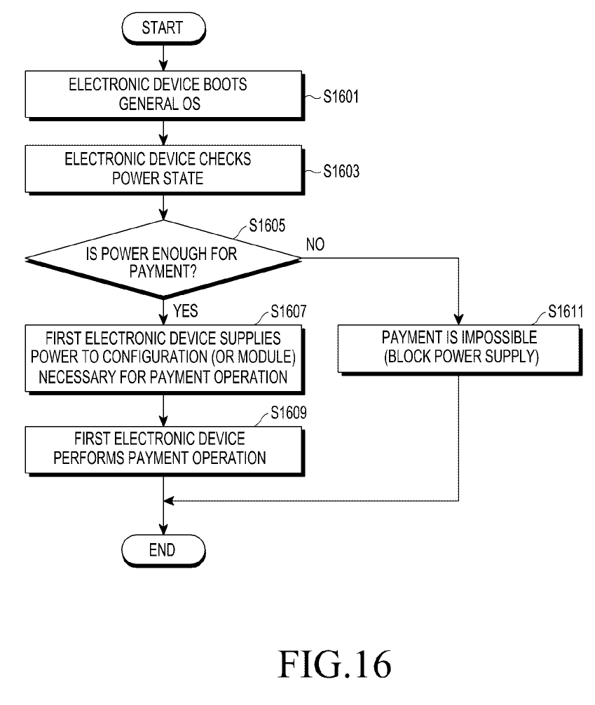

FIG. 16 is a flowchart illustrating an example booting operation of the first electronic device, according to various example embodiments of the present disclosure.

Referring to FIG. 16, the payment processing module 415 may perform the payment function. For example, the payment processing module 415 may control a function (or module) that is related to the payment function.

According to the embodiment, the payment processing module 415 may perform at least one of a fingerprint verification operation or payment operation. The payment processing module 415 may perform the payment function by using the communication module 420. The communication module 420 may be at least one of an NFC module, an MST (magnetic stripe transaction) module, a Bluetooth module, a cellular module, or a Wi-Fi module.

In operation S1601, the first electronic device 401 or 402 may boot the general OS, and may operate by using the booted general OS.

In operation S1603, the first electronic device 401 or 402 (e.g., the payment management module 412) may check the power state of the first electronic device 401 or 402 in response to the payment signal (PS).

In operation S1605, the first electronic device 401 or 402 (e.g., the payment management module 412) may determine whether or not the power is enough to perform the payment function.

According to the embodiment, the determination on whether or not the power is enough to perform the payment function may be made by identifying the power that is required for the processor 410 (e.g., the payment management module 412) to perform the fingerprint verification operation and to drive the payment processing module and the communication module 420 for the payment. For example, if the power that is required for driving the fingerprint sensor of the sensor module 440, the NFC module of the communication module 420, and the payment processing module 415 is less than the current power of the first electronic device 401 or 402, the processor 410 (e.g., the payment management module 412) may determine that the payment function can be executed.

In operation S1607, if the first electronic device 401 or 402 is in the power state in which the payment function can be executed, the first electronic device 401 or 402 may operate the payment processing module 415 by using a general OS.

In operation S1607, the first electronic device 401 or 402 may perform a function (or module) for performing the payment among a plurality of functions (or modules) of the electronic device 401 or 402 by using the general OS.

In addition, the first electronic device 401 or 402 may not perform functions (or modules) that are not necessary for performing the payment among a plurality of functions (or modules) of the electronic device 401 or 402 by using the general OS.

According to the embodiment, the power management module 430 may supply power to a device (or module) for performing the payment function such that only the device (or module) for performing the payment function can be operated under the control of the processor 410.

In operation S1609, the first electronic device 401 or 402 (e.g., the payment processing module 415) may perform the payment function by using the device (or module) for performing the payment function.

In operation S1611, if the first electronic device 401 or 402 is in the power state in which the payment function cannot be executed, the first electronic device 401 or 402 (e.g., the payment management module 412) may be turned off. In addition, if the first electronic device 401 or 402 is in the power state in which the payment function cannot be executed, the first electronic device 401 or 402 (e.g., the payment management module 412) may inform the user that the payment function cannot be executed.

In addition, if the first electronic device 401 or 402 is in the power state in which the payment function cannot be executed, the processor 410 (e.g., the payment management module 412) may control the first electronic device 401 or 402 to perform functions rather than the payment function.

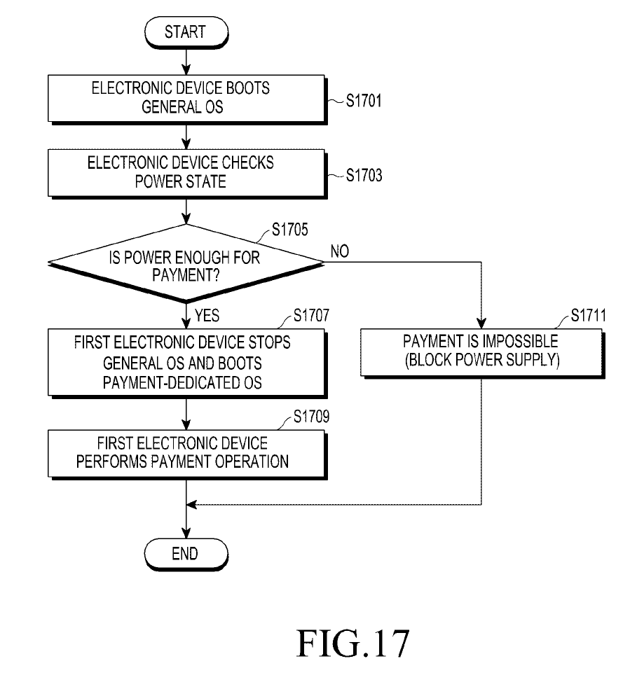

FIG. 17 is a flowchart illustrating an example booting operation of the first electronic device, according to various example embodiments of the present disclosure.

Referring to FIG. 17, the payment processing module 415 may perform the payment function. For example, the payment processing module 415 may include a payment-dedicated OS that is related to the payment function.

In operation S1701, the first electronic device 401 or 402 may boot a general OS, and may operate by using the booted general OS.

In operation S1703, the first electronic device 401 or 402 (e.g., the payment management module 412) may check the power state of the first electronic device 401 or 402 in response to the payment signal (PS).

In operation S1705, the first electronic device 401 or 402 (e.g., the payment management module 412) may determine whether or not the power is enough to perform the payment function. In addition, the first electronic device 401 or 402 may determine whether or not the power of the first electronic device 401 or 402 is enough to change (or switch) from the general OS to the payment-dedicated OS.

If the first electronic device 401 or 402 is in the power state in which the payment function can be executed, the processor 410 may change the operating system of the first electronic device 401 or 402 from the general OS into the payment-dedicated OS in operation S1707, and the first electronic device 401 or 402 may be operated in the changed payment-dedicated OS.

According to the embodiment, the first electronic device 401 or 402 may perform a function (or module) for performing the payment function among a plurality of functions (or modules) of the electronic device 401 or 402 by using the payment-dedicated OS.

In addition, the first electronic device 401 or 402 may not perform functions (or modules) that are not necessary for performing the payment function among a plurality of functions (or modules) of the electronic device 401 or 402 by using the payment-dedicated OS.

According to the embodiment, the power management module 430 may supply power to a module for performing the payment function such that only the module for performing the payment function can be operated under the control of the processor 410 (e.g., the payment management module 412).

In operation S1709, the first electronic device 401 or 402 may perform the payment function by using the payment-dedicated OS.

If the first electronic device 401 or 402 is in the power state in which the payment function cannot be executed, the first electronic device 401 or 402 (e.g., the payment management module 412) may be turned off in operation S1711.

In addition, if the first electronic device 401 or 402 is in the power state in which the payment function cannot be executed, the first electronic device 401 or 402 (e.g., the payment management module 412) may inform the user that the payment function cannot be executed.

According to various embodiments of the present disclosure, a method of operating an electronic device that includes a communication module (e.g., including communication circuitry), one or more sensors, and a processor may include: obtaining a gesture input with respect to the electronic device using the one or more sensors; performing a function that is related to payment using the processor if the gesture input satisfies a specified condition; and suppressing the 20 execution of the function if the gesture input does not satisfy the specified condition.

The obtaining of the gesture input may include: receiving a signal that requests payment from an external electronic device through the communication module when the electronic device is in the disabled state; and obtaining the gesture input at least based on the received signal requesting payment.

The receiving may include switching the electronic device from the disabled state into the enabled state at least based on the signal.

The one or more sensors may include a grip sensor, a fingerprint sensor, or a touch sensor, and the performing may include: determining the contact state of a user with respect to at least a portion of the electronic device at least based on the gesture input that is obtained using the grip sensor, the fingerprint sensor, or the touch sensor; and determining that the specified condition has been satisfied if it is determined that the user comes into contact with at least a portion of the electronic device.

The one or more sensors may include an infrared sensor, an image sensor, or an acceleration sensor, and the performing may include: determining at least one of the type, the size, or the speed of a gesture corresponding to the gesture input at least based on the gesture input that is obtained using the infrared sensor, the image sensor, or the acceleration sensor; and determining that the specified condition has been satisfied if it is determined that the type, the size, or the speed matches a specified type, a specified size, or a specified speed, respectively.

The performing may include performing verification on the electronic device or on the user by using an application for performing the function.

According to various example embodiments of the present disclosure, a method of operating an electronic device that includes a display, an antenna, and a processor may include: receiving a signal or an input that triggers a function that is related to payment through the antenna while the electronic device is in the disabled state; receiving verification information while the display is, at least in part, in the disabled state in response to receiving the signal or input; performing verification operation by using the processor at least based on the verification information; and outputting information that is related to the payment to the outside of the electronic device through the antenna at least based on the verification operation.

The receiving of the signal or input may include switching the electronic device from the disabled state into the enabled state at least based on the reception.

The receiving of the verification information may include receiving the verification information while power is not supplied to pixels in a specified area of the display.

The electronic device may further include one or more sensors, and the one or more sensors may include a fingerprint sensor, an iris sensor, a camera sensor, a sound sensor, or a heart-rate sensor, wherein the receiving of the verification information may include obtaining the verification information by using the fingerprint sensor, the iris sensor, the camera sensor, the sound sensor, or the heart-rate sensor.

Various embodiments of the present disclosure may provide a computer-readable recording medium that stores a program to perform, in an electronic device that includes a communication module, one or more sensors, and a processor, the operations of: obtaining a gesture input with respect to the electronic device using the one or more sensors; performing a function that is related to payment using the processor if the gesture input satisfies a specified condition; and suppressing the execution of the function if the gesture input does not satisfy a specified condition.

Each of the components of the electronic device according to the present disclosure may be implemented by one or more components and the name of the corresponding component may vary depending on a type of the electronic device. Some of the above-described elements may be omitted from the electronic device, or may further include additional elements. Further, some of the components of the electronic device according to the various embodiments of the present disclosure may be combined to form a single entity, and thus, may equivalently execute functions of the corresponding elements prior to the combination.

The embodiments disclosed herein are provided simply to easily describe technical details of the present disclosure and to aid in the understanding of the present disclosure, and are not intended to limit the scope of the present disclosure. Therefore, it should be construed that all modifications and changes or modified and changed forms based on the technical idea of the present disclosure fall within the scope of the present disclosure.

What is claimed is:

1. An electronic device comprising:
a communication module comprising communication circuitry and an antenna;
one or more sensors; and
a processor, wherein the processor is configured to: obtain a gesture input with respect to the electronic device using the one or more sensors; perform a function related to payment if the gesture input satisfies a specified condition; and
suppress the execution of the function if the gesture input does not satisfy the specified condition.

2. The electronic device according to claim 1, wherein the processor is configured to receive a signal that requests payment from an external electronic device through the communication circuitry of the communication module when the electronic device is in a disabled state.

3. The electronic device according to claim 2, wherein the processor is configured to switch the electronic device from the disabled state to an enabled state based on the signal.

4. The electronic device according to claim 2, further comprising a low-power processor, wherein the low-power processor is configured to perform the function in the disabled state based on the signal.

5. The electronic device according to claim 2, wherein the processor is configured to obtain the gesture input based on the signal.

6. The electronic device according to claim 1, wherein the one or more sensors comprise one or more of a grip sensor, a fingerprint sensor, or a touch sensor, and
the processor is configured to: determine a contact state with respect to at least a portion of the electronic device based on the gesture input that is obtained using the grip sensor, the fingerprint sensor, or the touch sensor; and determine that the specified condition has been satisfied if it is determined that the contact state indicates contact with at least a portion of the electronic device.

7. The electronic device according to claim 1, wherein the one or more sensors comprise one or more of an infrared sensor, an image sensor, or an acceleration sensor, and
wherein the processor is configured to: determine the type, the size, or the speed of a gesture corresponding to the gesture input based on the gesture input obtained using the infrared sensor, the image sensor, or the acceleration sensor; and determine that the specified condition has been satisfied if it is determined that the type, the size, or the speed matches a specified type, a specified size, or a specified speed, respectively.

8. The electronic device according to claim 1, wherein the processor is configured to perform verification on the electronic device using an application for performing the function.

9. The electronic device according to claim 8, wherein the sensors comprise one or more of a fingerprint sensor, an iris sensor, a camera sensor, a sound sensor, or a heart-rate sensor, and
wherein the processor is configured to: obtain one or more pieces of biometric information using a corresponding sensor from among the fingerprint sensor, the iris sensor, the camera sensor, the sound sensor, or the heart-rate sensor; and perform the verification and the function based on the one or more pieces of biometric information.

10. The electronic device according to claim 9, wherein the processor is configured to transmit a request for performing the payment to an external electronic device using the communication circuitry of the communication module if the verification is successful.

11. The electronic device according to claim 8, further comprising a display, wherein the processor is configured to receive information corresponding to a user for the verification while the display is disabled.

12. The electronic device according to claim 8, wherein the processor is configured to perform the verification based on a power state of the electronic device.

13. The electronic device according to claim 8, wherein the processor is configured to receive user information from an external electronic device that is functionally connected to the electronic device.

14. The electronic device according to claim 1, wherein the antenna comprises at least one of an NFC (near field communication) antenna or an MST (magnetic secure transmission) antenna.

15. An electronic device comprising:
a wireless communications antenna;
a touch screen display;
a processor electrically connected to the display; and
a memory electrically connected to the processor,
wherein the memory is configured to store instructions that, when executed, cause the processor to:
receive a signal or an input that triggers a function related to payment while the electronic device is in a disabled state;
receive verification information in response to receiving the signal or input while the display is, at least in part, turned off;
perform a verification operation based on the verification information; and
output information related to the payment to the outside of the electronic device through the antenna based on the verification operation.

16. A method of operating an electronic device that includes a communication module comprising communication circuitry, one or more sensors, and a processor, the method comprising:
obtaining a gesture input with respect to the electronic device using the one or more sensors;
performing a function related to payment using the processor if the gesture input satisfies a specified condition; and
suppressing the execution of the function if the gesture input does not satisfy the specified condition.

17. The method according to claim 16, wherein the obtaining of the gesture input comprises:
receiving a signal that requests payment from an external electronic device when the electronic device is in a disabled state; and
obtaining the gesture input based on the receiving the signal.

18. The method according to claim 17, wherein the receiving comprises switching the electronic device from the disabled state to an enabled state based on the signal.

19. The method according to claim 16, wherein the one or more sensors comprise one or more of a grip sensor, a fingerprint sensor, or a touch sensor, and
wherein the performing comprises:
determining a contact state with respect to at least a portion of the electronic device based on the gesture input obtained using the grip sensor, the fingerprint sensor, or the touch sensor; and
determining that the specified condition has been satisfied if it is determined that the contact state indicates contact with at least a portion of the electronic device.

20. The method according to claim 16, wherein the one or more sensors comprise one or more of an infrared sensor, an image sensor, or an acceleration sensor, and
wherein the performing comprises:
determining at least one of the type, the size, or the speed of a gesture corresponding to the gesture input based on the gesture input obtained using the infrared sensor, the image sensor, or the acceleration sensor; and
determining that the specified condition has been satisfied if it is determined that the type, the size, or the speed matches a specified type, a specified size, or a specified speed, respectively.
